(19) United States
(12) Patent Application Publication
(10) Pub. No.: US 2024/0004921 A1
(43) Pub. Date: Jan. 4, 2024

(54) INFORMATION PROCESSING SYSTEM, INFORMATION PROCESSING METHOD, AND NON-TRANSITORY RECORDING MEDIUM

(71) Applicant: Toshihiro Kai, Kanagawa (JP)

(72) Inventor: Toshihiro Kai, Kanagawa (JP)

(73) Assignee: Ricoh Company, Ltd., Tokyo (JP)

(21) Appl. No.: 18/336,503

(22) Filed: Jun. 16, 2023

(30) Foreign Application Priority Data
Jul. 4, 2022 (JP) 2022-107838

(51) Int. Cl. G06F 16/532; G06V 30/32; G06F 16/54

(52) U.S. Cl. CPC G06F 16/532; G06V 30/347; G06F 16/54

(57) ABSTRACT

An information processing system includes circuitry. In response to receiving, from a terminal apparatus, a search request for searching minutes using user information as a search key, the minutes including handwritten data having been displayed on a display, the circuitry is to search a memory that stores, in association with user information, a plurality of pieces of handwritten data divided into one or more groups in accordance with a predetermined rule, to obtain a search result including the one or more groups of handwritten data that match the user information. The circuitry is also to transmit the search result including the one or more groups of handwritten data that match the user information to the terminal apparatus.

### CROSS-REFERENCE TO RELATED APPLICATIONS

This patent application is based on and claims priority pursuant to 35 U.S.C. § 119(a) to Japanese Patent Application No. 2022-107838, filed on Jul. 4, 2022, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

There are display apparatuses such as electronic whiteboards having a touch panel display that displays an image of handwritten data drawn by a user with a dedicated electronic pen or a finger. Unlike a conventional whiteboard, such a display apparatus can store handwritten data as electronic data and display an image of a material being displayed by an external device, such as a personal computer (PC), connected to the display apparatus.

There has been known a technique for searching for display information displayed by such a display apparatus. For example, there is a display apparatus that can search for even free-form curves drawn by a user as characters by digitizing the free-form curves, to display a search result.

### SUMMARY

In one aspect, an information processing system includes circuitry. In response to receiving, from a terminal apparatus, a search request for searching minutes using user information as a search key, the minutes including handwritten data having been displayed on a display, the circuitry is to search a memory that stores, in association with user information, a plurality of pieces of handwritten data divided into one or more groups in accordance with a predetermined rule, to obtain a search result including the one or more groups of handwritten data that match the user information. The circuitry is also to transmit the search result including the one or more groups of handwritten data that match the user information to the terminal apparatus.

In another aspect, an information processing method includes receiving, from a terminal apparatus, a search request for searching minutes using user information as a search key, the minutes including handwritten data having been displayed on a display, searching a memory that stores, in association with user information, a plurality of pieces of handwritten data divided into one or more groups in accordance with a predetermined rule, to obtain a search result including the one or more groups of handwritten data that match the user information, and transmitting a search result including the one or more groups of handwritten data that match the user information to the terminal apparatus.

In another aspect, a non-transitory recording medium storing a plurality of program codes which, when executed by one or more processors, causes the processors to perform an information processing method. The method includes receiving, from a terminal apparatus, a search request for searching minutes using user information as a search key, the minutes including handwritten data having been displayed on a display, searching a memory that stores, in association with user information, a plurality of pieces of handwritten data divided into one or more groups in accordance with a predetermined rule, to obtain a search result including the one or more groups of handwritten data that match the user information, and transmitting a search result including the one or more groups of handwritten data that match the user information to the terminal apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are diagrams illustrating operations for finding target handwritten data by searching according to an embodiment of the present disclosure;

FIG. 2 is a diagram illustrating a method of searching for a record according to the embodiment of the present disclosure;

FIG. 3 is a schematic diagram illustrating an overview of creating a record in which an application screen of an application executed in a teleconference is stored together with a panoramic image of surroundings according to the embodiment of the present disclosure;

FIG. 4 is a diagram illustrating an example of a configuration of a record creation system according to the embodiment of the present disclosure;

FIG. 5 is a block diagram illustrating an example of a hardware configuration of an information processing system and a terminal apparatus according to the embodiment of the present disclosure;

FIG. 6 is a block diagram illustrating an example of a hardware configuration of a meeting device according to the embodiment of the present disclosure;

FIG. 7 is a schematic diagram illustrating an imaging range of the meeting device according to the embodiment of the present disclosure;

FIG. 8 is a schematic diagram illustrating a panoramic image and processing to cut out talker images from the panoramic image according to the embodiment of the present disclosure;

FIG. 9 is a block diagram illustrating a hardware configuration of an electronic whiteboard according to the embodiment of the present disclosure;

FIG. 10 is a block diagram illustrating an example of functional configurations of the terminal apparatus, the meeting device, and the information processing system of the record creation system according to the embodiment of the present disclosure;

FIG. 11 is a diagram illustrating an example of data structure of information on a recorded video stored in an information storage area according to the embodiment of the present disclosure;

FIG. 12 is a diagram illustrating an example of data structure of conference information managed by a communication management unit according to the embodiment of the present disclosure;

FIG. 13 is a diagram illustrating an example of data structure of association information associating device identifiers with conference identification information (ID) each other, stored in an association information storage area, according to the embodiment of the present disclosure;

FIG. 14 is a diagram illustrating an example of data structure of user information stored in a user information storage area according to the embodiment of the present disclosure;

FIG. 15 is a diagram illustrating an example of data structure of a record and object information stored in a record storage unit according to the embodiment of the present disclosure;

FIG. 16 is a diagram illustrating an example of data structure of text data which is a part of a record according to the embodiment of the present disclosure;

FIG. 17 is a block diagram illustrating an example of functional configurations of the electronic whiteboard according to the embodiment of the present disclosure;

FIG. 18 is a diagram illustrating an example of data structure of device identification information stored in a device information storage area according to the embodiment of the present disclosure;

FIG. 19 is a diagram illustrating an example of data structure of object information stored in an object information storage area according to the embodiment of the present disclosure;

FIG. 20 is a diagram illustrating a relationship among strokes, handwritten data, and handwritten material according to the embodiment of the present disclosure;

FIG. 21 is a diagram illustrating association among conference information, handwritten data, stroke data, and user information according to the embodiment of the present disclosure;

FIG. 22 is a diagram illustrating a method of dividing handwritten data according to the embodiment of the present disclosure;

FIG. 23 is a diagram illustrating an example of a composite image video display screen displayed by an information recording application according to the embodiment of the present disclosure;

FIG. 24 is a diagram illustrating an example of a search menu screen according to the embodiment of the present disclosure;

FIG. 25 is a diagram illustrating an example of a search screen displayed by the terminal apparatus when a search by conference participant button is pressed, according to the embodiment of the present disclosure;

FIG. 26 is a diagram illustrating an example of a search result screen that presents a search result transmitted from the information processing system according to the embodiment of the present disclosure;

FIG. 27 is a diagram illustrating an example of a search condition setting screen according to the embodiment of the present disclosure;

FIGS. 28A and 28B (FIG. 28) are sequence charts illustrating an example of processing executed by the information recording application to record a panoramic image, a talker image, and an application screen, according to the embodiment of the present disclosure; and

FIG. 29 is a sequence chart illustrating an example of an operation performed by a user to search for a record and object information recorded in a conference, according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, descriptions are given of a record creation system and an information processing method performed by the record creation system as an exemplary embodiment of the present disclosure.

Overview of Searching for Handwritten Data

When a participant handwrites an object on an electronic whiteboard or the like at a conference, handwritten data of the object displayed on the electronic whiteboard is stored in association with the conference. Any user may desire to reuse or check the handwritten data based on a participant in the conference. In this case, the user is required to search for object information that includes handwritten data and the like with a name of the participant and open the object information to check whether the desired handwritten data is included in the object information obtained by the search. However, there have been cases where one piece of object information is too large to know whether desired contents are included. In other words, there have been cases where the user hardly finds the target handwritten data when the user searches for object information with the name of the participant.

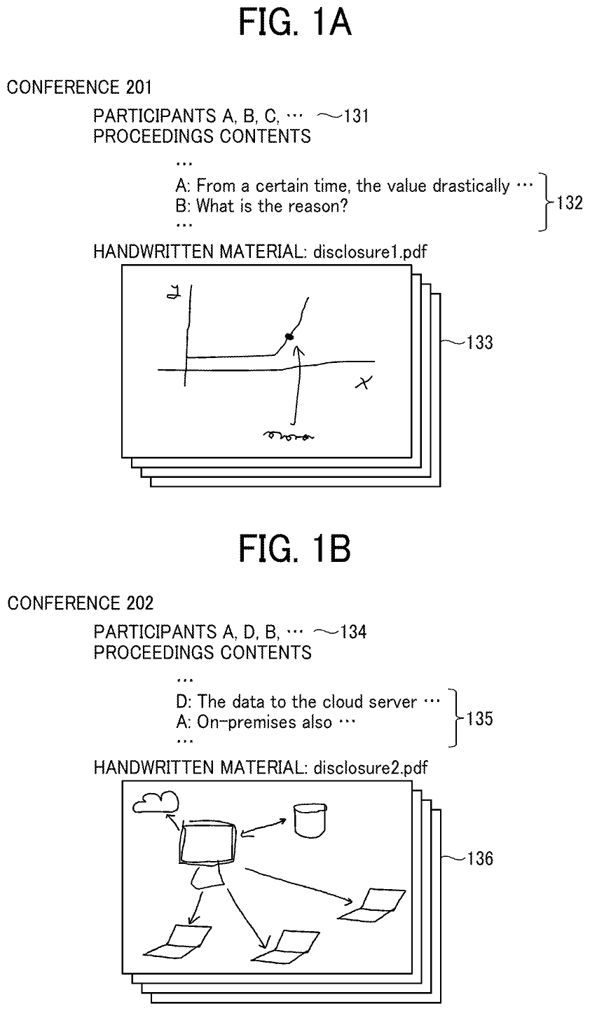

FIGS. 1A and 1B are diagrams illustrating operations for finding target handwritten data by searching. As illustrated in FIG. 1A, a conference 201 is held, and information on participants 131, text data 132 of proceedings contents, a plurality of pieces of handwritten data 133 of handwritten material, and the like are stored in association with the conference 201. Also, as illustrated in FIG. 1B, a conference 202 is held, and information on participants 134, text data 135 of proceedings contents, a plurality of pieces of handwritten data 136 of handwritten material, and the like are stored in association with the conference 202. It is assumed that a user desires to check a drawing drafted by a person A among the plurality of pieces of handwritten data. This is, for example, a situation such as “I want to see again the explanatory drawing drafted by the person A at the conference. To which minutes of a conference is the explanatory drawing attached?”

In this case, it is assumed that the user searches for minutes by the name of the person A as one of searching methods. As illustrated in FIGS. 1A and 1B, the entire minutes of all the conferences in which the person A has participated are output. As a result, the user hardly finds handwritten data drawn by the person A. This is because the minutes include handwritten data drawn by participants other than the person A.

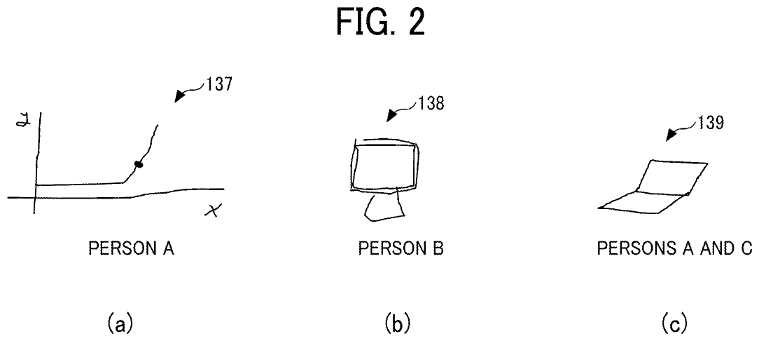

In view of the above, in the present embodiment, the handwritten data is divided into pieces of handwritten data each having some meaning, and a writer is associated with each piece of handwritten data having some meaning as illustrated in FIG. 2. FIG. 2 is a diagram illustrating a method of searching for handwritten data according to the present embodiment.

In the present embodiment, identification information of a writer is stored in association with handwritten data. The handwritten data is formed of one or more strokes that have some meaning to the user. In FIG. 2, the writer of handwritten data 137 is the person A, the writer of handwritten data 138 is a person B, and the writers of handwritten data 139 are the person A and a person C. In a case where the user searches for handwritten data by “the person A,” the handwritten data 137 and 139 match the search condition. Thus, the user can easily find the target handwritten data.

As described above, by associating a writer with one or more strokes that have some meaning, the searching method of the present embodiment allows providing not the entire minutes but the one or more strokes drawn by a participant that is the writer in meaningful units. Accordingly, the user can easily find the target handwritten data.

Terminology

The term “input means” refers to any device that allows handwriting by designating coordinates on a touch panel. Examples of the input device include, but are not limited to, a stick-shaped member such as an electronic pen, and a portion of a user such as a human finger or a human hand.

A series of user operations including engaging a writing mode, recording movement of an input device or portion of a user, and then disengaging the writing mode is referred to as a stroke. The term “stroke” includes tracking movement of the input device or portion of the user without contacting a display or screen. In this case, the writing mode may be engaged or turned on by a gesture of a user, pressing a button by a hand or a foot of the user, or otherwise turning on the writing mode, for example using a mouse or any other pointing device. Further, the disengaging of the writing mode can be accomplished by the same or different gesture used to engage the writing mode, releasing the button, or otherwise turning off the writing mode, for example using the mouse or any other pointing device.

The term “stroke data” refers to information that is displayed on a display based on a trajectory of coordinates input with the input means such as the input device. The stroke data may be interpolated appropriately. The term “handwritten data” refers to data having one or more pieces of stroke data. The handwritten data may alternatively be referred to as hand-drafted data, as the handwritten data may represent not only writing, but drawing. Examples of the handwritten data include, but are not limited to, drawing of a figure using a drawing tool (e.g., a linear drawing tool or a circular drawing tool). The term “handwritten input” refers to a user input such as handwriting, drawing, and other forms of input. The handwritten input may be performed via a touch interface, with a tactile object such as a pen or stylus or with the user's body. The handwritten input may also be performed via other types of input, such as gesture-based input, hand motion tracking input, or other touch-free input by a user. Some embodiments of the present disclosure described below relate to handwritten input and handwritten input data, but other forms of handwritten input may be utilized and are within the scope of the present disclosure. For the descriptive purposes, in this disclosure, stroke data, which is data of stroke(s), and stroke(s) input by the user may be used interchangeably.

The term “object” refers to an item displayed on a display based on stroke data. The object in this specification also represents an object to be displayed. An object obtained by handwriting recognition and conversion of stroke data may include, in addition to text, a stamp displayed as a given character or mark such as “complete,” a shape such as a circle or a star, or a line. The term “text” refers to a character string (character code) mainly including one or more characters and may also include numerals and symbols. The text may be referred to as a character string.

The term “user information” refers to any information that can identify a user. In the present embodiment, the user information is described by the term “a name of a participant” or “user identification information (ID).” The name of a participant and the user ID are interchangeable.

The term “storage device” refers to any device that stores minutes. The minutes are information in which contents discussed and matters decided at a conference are recorded. In the present embodiment, a record (composite image video, text data) and object information are stored in the minutes. A record storage unit 7001 is an example of the storage device. The record storage unit 7001 may be included in an information processing system.

The term “conference” refers to exchanging opinions for a specific objective and making a decision such as an agreement or a measure among persons concerned (participants) in a face-to-face manner or remotely. The conference is also referred to as a party, an assembly, a convention, a get-together, a gathering, a meeting, or the like.

The term “predetermined rule” refers to a rule regarding how to divide a plurality of pieces of stroke data handwritten by users. The rule may also be referred to as a condition. In the present embodiment, the rule is determined, for example, based on a time interval between a time when one piece of stroke data is input and a time when another piece of stroke data is input.

Example of Method of Creating Minutes of Teleconference

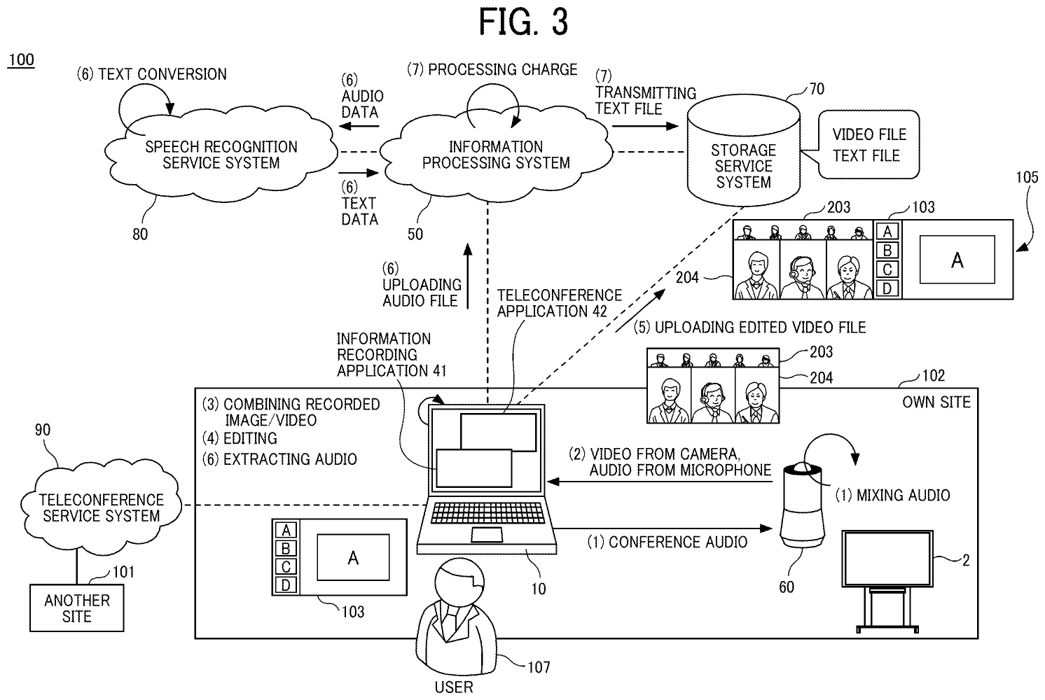

With reference to FIG. 3, an overview of a method of creating minutes using a panoramic image and an application screen is described. FIG. 3 is a schematic diagram illustrating an overview of creating a record in which an application screen of an application executed in a teleconference is stored together with a panoramic image of surroundings. As illustrated in FIG. 3, a user at an own site 102 uses a teleconference service system 90 to hold a teleconference with another user at another site 101.

A record creation system 100 according to the present embodiment includes a terminal apparatus 10 and a meeting device 60 that includes an imaging device, a microphone, and a speaker. The record creation system 100 creates a record (minutes) using a screen generated by an application executed by the terminal apparatus 10 and a horizontal panoramic image (hereinafter referred to as a panoramic image) captured by the meeting device 60. The record creation system 100 synthesizes audio data received by a teleconference application 42 operating on the terminal apparatus 10 and audio data obtained by the meeting device 60 together, and includes the resultant synthesized audio data in the record. The overview is described below.

(1) On the terminal apparatus 10, an information recording application 41 to be described later and the teleconference application 42 are operating. In addition, another application such as a document display application may also be operating on the terminal apparatus 10. The information recording application 41 transmits audio data output from the terminal apparatus 10 (including audio data received by the teleconference application 42 from the other site 101) to the meeting device 60. The meeting device 60 mixes (synthesizes) the audio data obtained by the meeting device 60 and the audio data received by the teleconference application 42.

(2) The meeting device 60 executes processing of cutting out an image of a talker from a panoramic image based on a direction from which audio is collected by the microphone included in the meeting device 60 and generates a talker image. The meeting device 60 transmits both the panoramic image and the talker image to the terminal apparatus

(3) The information recording application 41 operating on the terminal apparatus 10 displays a panoramic image 203 and talker images 204. The information recording application 41 combines the panoramic image 203 and the talker images 204 with an application screen (e.g., an application screen 103 of the teleconference application 42) freely selected by the user. For example, the information recording application 41 combines the panoramic image 203 and the talker images 204 with the application screen 103 of the teleconference application 42 to generate a composite image 105 such that the panoramic image 203 and the talker images 204 are arranged on the left side and the application screen 103 is arranged on the right side. Since the processing (3) is repeatedly executed, the resultant composite images 105 become a video (hereinafter referred to as a composite image video). Further, the information recording application 41 attaches the synthesized audio data to the composite image video to generate a video with audio.

In the present embodiment, an example of combining the panoramic image 203 and the talker images 204 with the application screen 103 is described. Alternatively, the information recording application 41 may store these images separately and arrange these images on a screen at the time of replay.

(4) The information recording application 41 receives an editing operation (performed by the user to cut off portions not to be used), and completes the composite image video. The composite image video forms a part of the record.

(5) The information recording application 41 transmits the generated composite image video (with audio) to a storage service system 70 for storage.

(6) The information recording application 41 extracts only the audio data from the composite image video (or may use the audio data before being combined) and transmits the extracted audio data to an information processing system 50. The information processing system 50 receives the audio data and transmits the audio data to a speech recognition service system 80 that converts audio data into text data. The speech recognition service system 80 converts the audio data into text data. The text data includes data indicating an elapsed time, from a start of recording, when the audio data is generated. That is, the text data includes data indicating how many minutes have elapsed from a start of recording until utterance.

In a case where the text conversion is performed in real time, the meeting device 60 transmits the audio data directly to the information processing system 50. The information processing system 50 transmits the text data obtained by speech recognition to the information recording application 41 in real time.

(7) The information processing system 50 transmits the text data to the storage service system 70 for storage in addition to the composite image video. The text data forms a part of the record.

Note that the information processing system 50 has a function to execute processing of charging the user according to the service used by the user. For example, a charging fee is calculated based on an amount of the text data, a file size of the composite image video, or processing time.

As described above, in the composite image video, a panoramic image of surroundings including the user and the talker images are displayed. Further, in the composite image video, an application screen of an application such as the teleconference application 42 displayed in the teleconference is displayed. When a participant of the teleconference or a person who has not participated in the teleconference browses the composite image video as the minutes, scenes in the teleconference are reproduced with a sense of presence.

Configuration of Record Creation System

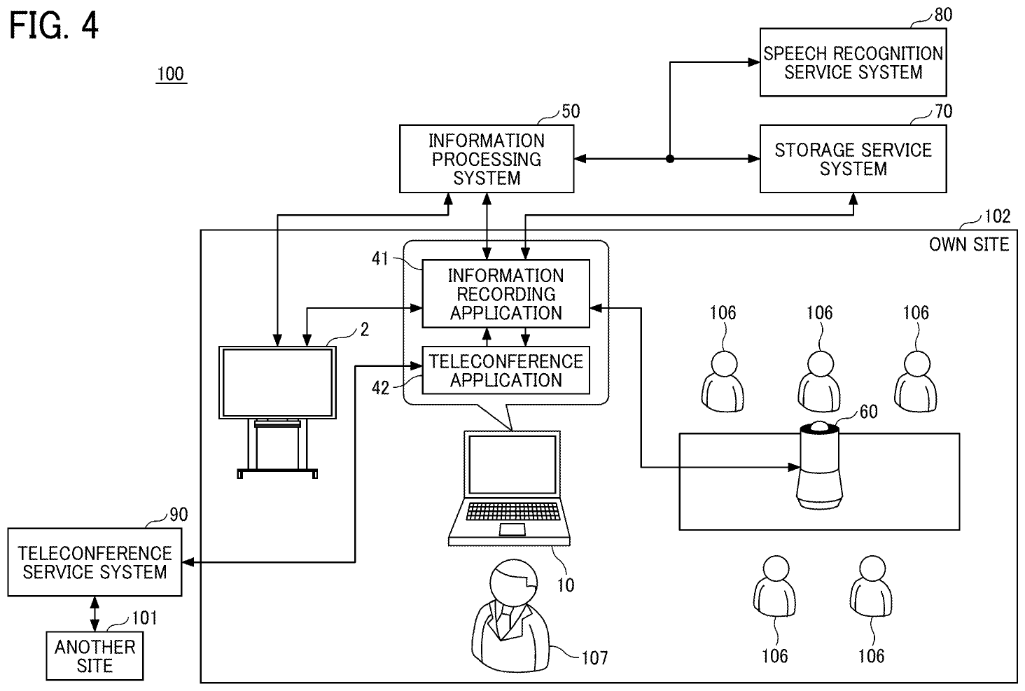

With reference to FIG. 4, a configuration of the record creation system 100 is described. FIG. 4 is a diagram illustrating an example of a configuration of the record creation system 100. In FIG. 4, one site (the own site 102) out of a plurality of sites among which a teleconference is held is illustrated. The terminal apparatus 10 located at the own site 102 communicates with the information processing system 50, the storage service system and the teleconference service system 90 via a network. In addition, the meeting device and the electronic whiteboard 2 are placed in the own site 102. The terminal apparatus 10 is communicably connected to the meeting device 60 via a universal serial bus (USB) cable or the like. The meeting device 60, the electronic whiteboard 2, and the information processing system 50 operate as a device management system.

On the terminal apparatus 10, at least the information recording application 41 and the teleconference application 42 operate. The teleconference application 42 communicates with another terminal apparatus 10 located at the other site 101 via the teleconference service system 90 residing on the network to allow users at each site to participate remotely in the teleconference. The information recording application 41 uses functions of the information processing system 50 and the meeting device 60 to create a record of the teleconference held by the teleconference application 42.

In the present embodiment, an example of creating a record of a teleconference is described. However, in another example, the conference is not necessarily a conference that involves communication to a remote site. In other words, the conference may be a conference in which participants at a single site participate. In this case, the image captured by the meeting device 60 and the audio collected by the meeting device 60 are independently stored without being combined. The rest of the processing executed by the information recording application 41 remains unchanged.

The terminal apparatus 10 includes a built-in (or external) camera having an ordinary angle of view. The camera included in the terminal apparatus 10 captures an image of a front space including a user 107 who operates the terminal apparatus 10. Images captured by the camera having an ordinary angle of view are not panoramic images. In the present embodiment, the built-in camera having the ordinary angle of view primarily captures planar images that are not curved like spherical images. Thus, the user can participate in a teleconference using the teleconference application 42 as usual without paying attention to the information recording application 41. The information recording application 41 and the meeting device 60 do not affect the teleconference application 42 except for an increase in the processing load of the terminal apparatus 10. The teleconference application 42 can transmit a panoramic image or a talker image captured by the meeting device 60 to the teleconference service system 90.

The information recording application 41 communicates with the meeting device 60 to create a record of a conference. The information recording application 41 also synthesizes audio collected by the meeting device 60 and audio received by the teleconference application 42 from another site. Alternatively, the meeting device 60, in place of the information recording application 41, may synthesize the audio collected by the meeting device 60 and the audio received by the teleconference application 42 from another site. The meeting device is a device for a conference, including an imaging device that can capture a panoramic image, a microphone, and a speaker. The camera included in the terminal apparatus 10 captures an image of only a limited range of the front space. In contrast, the meeting device captures an image of the entire surroundings (not necessarily the entire surroundings) around the meeting device 60. The meeting device 60 can keep a plurality of participants 106 illustrated in FIG. 4 within the angle of view at all times.

In addition, the meeting device 60 cuts out a talker image from a panoramic image. The meeting device 60 is placed on a table, but may be placed anywhere in the own site 102. Since the meeting device 60 can capture a spherical image, the meeting device 60 may be disposed, for example, on a ceiling.

The information recording application 41 displays a list of applications operating on the terminal apparatus 10, combines images for creating the above-described record (generates a composite image video), replays the composite image video, and receives editing. Further, the information recording application 41 displays a list of teleconferences already held or to be held in the future. The list of teleconferences is used in information on the record to allow the user to link a teleconference with the record.

The teleconference application 42 establishes communication connection with the other site 101, transmits and receives images and audio to and from the other site 101, displays images, and outputs audio.

The information recording application 41 and the teleconference application 42 each may be a web application or a native application. The web application is an application in which a program on a web server and a program on a web browser cooperate with each other to perform processing. The web application does not have to be installed in the terminal apparatus 10. The native application is an application that is installed in the terminal apparatus 10 for use. In the present embodiment, both the information recording application 41 and the teleconference application 42 are described as native applications.

The terminal apparatus 10 may be, for example, a general-purpose information processing apparatus having a communication function, such as a personal computer (PC), a smartphone, or a tablet terminal. Alternatively, the terminal apparatus 10 may be, for example, an electronic whiteboard, a game console, a personal digital assistant (PDA), a wearable PC, a car navigation system, an industrial machine, a medical device, or a networked home appliance. The terminal apparatus 10 may be any apparatus on which the information recording application 41 and the teleconference application 42 operate.

The electronic whiteboard 2 displays, on a display, data handwritten on a touch panel with an input device such as a pen or a portion of the user such as a finger. The electronic whiteboard 2 communicates with the terminal apparatus 10 by wired or wireless communication, and can capture a screen displayed by the terminal apparatus 10 to display the captured screen on the display. The electronic whiteboard 2 can convert handwritten data into text data, and can share information displayed on the display with another electronic whiteboard 2 located at another site. The electronic whiteboard 2 may be simply a whiteboard not including a touch panel, onto which a projector projects an image. The electronic whiteboard 2 may be, for example, a tablet terminal including a touch panel, a notebook PC, a PDA, or a game console.

The electronic whiteboard 2 communicates with the information processing system 50. For example, after being powered on, the electronic whiteboard 2 performs polling on the information processing system 50 to receive information from the information processing system 50.

The information processing system 50 is implemented by one or more information processing apparatuses residing on a network. The information processing system 50 includes at least one server application that performs processing in cooperation with the information recording application 41, and provides basic services. The server application manages a list of teleconferences, records recorded in teleconferences, various settings, and path information of storages. Examples of the basic services are user authentication, processing of contracting, and processing of charging. Thus, the information processing system may be referred to as an information processing server.

All or some of the functions of the information processing system 50 may reside in a cloud environment or in an on-premises environment. The information processing system 50 may be implemented by a plurality of server apparatuses or may be implemented by a single information processing apparatus. For example, the server application and the basic services may be provided by different information processing apparatuses. Further, each function of the server application may be provided by an individual information processing apparatus. The information processing system 50 may be integral with the storage service system 70 and the speech recognition service system 80 to be described below.

The storage service system 70 is a storage on a network and provides a storage service for accepting the storage of files and the like. Examples of the storage service system include MICROSOFT ONEDRIVE, GOOGLE WORKSPACE, and DROPBOX. The storage service system 70 may be, for example, a Network Attached Storage (NAS) in an on-premises environment.

The speech recognition service system 80 performs speech recognition on audio data to provide a service for converting the audio data into text data. The speech recognition service system 80 may be, for example, a general commercial service or a part of the functions of the information processing system 50.

Hardware Configurations

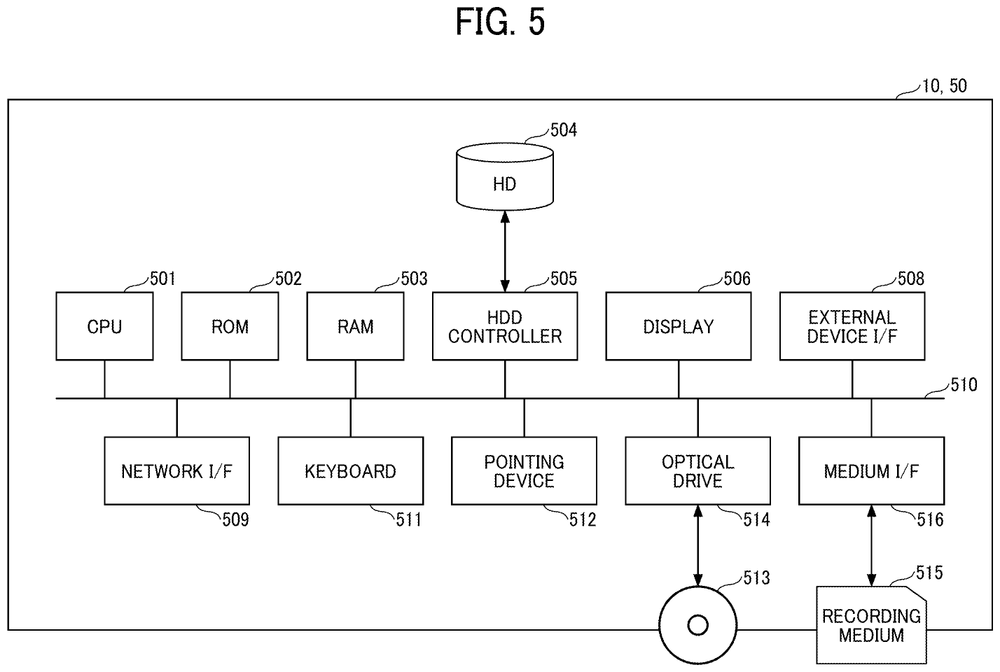

With reference to FIG. 5, a hardware configuration of the information processing system 50 and the terminal apparatus 10 according to the present embodiment is described.

Information Processing System and Terminal Apparatus

FIG. 5 is a block diagram illustrating an example of a hardware configuration of the information processing system 50 and the terminal apparatus 10 according to the present embodiment. As illustrated in FIG. 5, each of the information processing system 50 and the terminal apparatus 10 is implemented by a computer. The computer includes a central processing unit (CPU) 501, a read only memory (ROM) 502, a random access memory (RAM) 503, a hard disk (HD) 504, a hard disk drive (HDD) controller 505, a display 506, an external device interface (UF) 508, a network OF 509, a bus line 510, a keyboard 511, a pointing device 512, an optical drive 514, and a medium OF 516.

The CPU 501 controls entire operation of one of the information processing system and the terminal apparatus 10 to which the CPU 501 belongs. The ROM 502 stores a program such as an initial program loader (IPL) used for driving the CPU 501. The RAM 503 is used as a work area for the CPU 501. The HD 504 stores various data such as a control program. The HDD controller 505 controls reading and writing of various data from and to the HD 504 under control of the CPU 501. The display 506 displays various information such as a cursor, a menu, a window, characters, and images. The external device OF 508 is an interface for connection with various external devices. Examples of the external devices include, but are not limited to, a USB memory and a printer. The network OF 509 is an interface for data communication through a communication network. The bus line 510 may be an address bus or a data bus, which electrically connects various elements such as the CPU 501 illustrated in FIG. 5.

The keyboard 511 is an example of an input device including a plurality of keys used for inputting characters, numerical values, various instructions, and the like. The pointing device 512 is an example of an input device that allows a user to select or execute various instructions, select an object for processing, and move a cursor being displayed. The optical drive 514 controls reading and writing of various data from and to an optical recording medium 513, which is an example of a removable recording medium. The optical recording medium 513 may be a compact disc (CD), a digital versatile disc (DVD), BLU-RAY disc, or the like. The medium OF 516 controls reading and writing (storing) of data from and to a recording medium 515 such as a flash memory.

Meeting Device

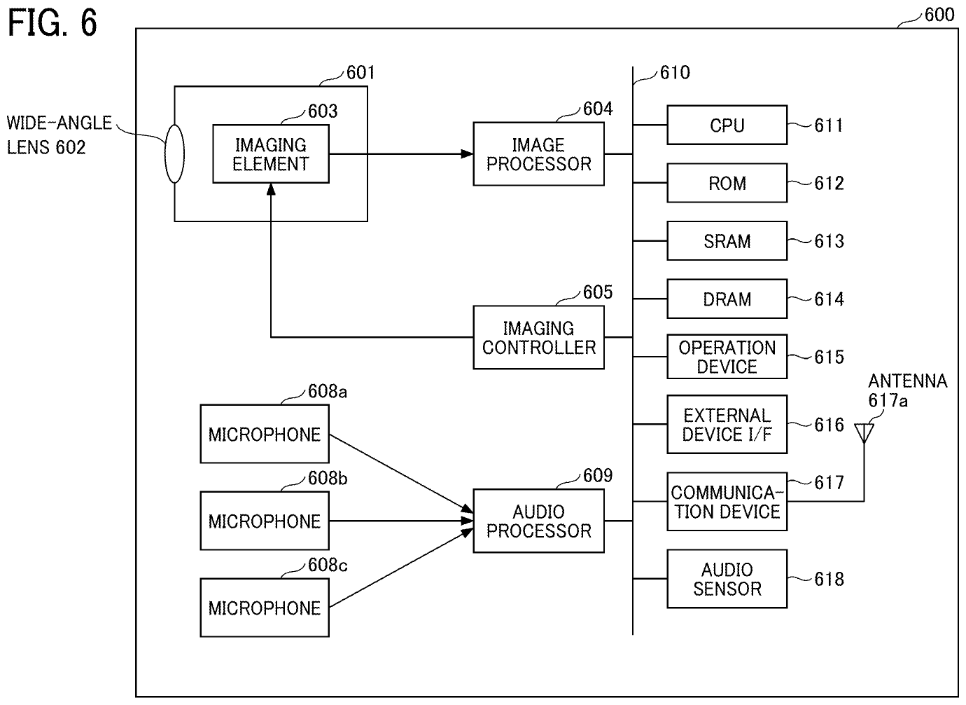

With reference to FIG. 6, a hardware configuration of the meeting device 60 is described. FIG. 6 is a block diagram illustrating an example of a hardware configuration of the meeting device 60 that can capture a video of surroundings in 360 degrees. In the following description, the meeting device 60 is assumed to be a device that uses an imaging element to capture a video of surroundings in 360 degrees around the device at a predetermined height. The number of imaging elements may be one or two or more. The meeting device 60 is not necessarily a dedicated device. Alternatively, an external imaging unit that can capture a video of surroundings in 360 degrees may be retrofitted to a PC, a digital camera, or a smartphone to implement a meeting device having substantially the same functions as those of the meeting device 60.

As illustrated in FIG. 6, the meeting device 60 includes an imaging device 601, an image processor 604, an imaging controller 605, microphones 608a to 608c, an audio processor 609, a CPU 611, a ROM 612, a static random access memory (SRAM) 613, a dynamic random access memory (DRAM) 614, an operation device 615, an external device OF 616, a communication device 617, an antenna 617a, and an audio sensor 618.

The imaging device 601 includes a wide-angle lens 602 (so-called a fish-eye lens) having an angle of view of 360 degrees to form a hemispherical image, and an imaging element 603 (an image sensor) provided for the wide-angle lens 602. The imaging element 603 includes an imaging sensor such as a complementary metal oxide semiconductor (CMOS) sensor or a charge-coupled device (CCD) sensor, a timing generation circuit, and a group of registers. The imaging sensor converts an optical image formed by the wide-angle lens 602 into electric signals to output image data. The timing generation circuit generates horizontal or vertical synchronization signals, pixel clocks, and the like for the imaging sensor. Various commands, parameters, and the like for operations of the imaging element 603 are set in the group of registers.

The imaging element 603 (image sensor) of the imaging device 601 is connected to the image processor 604 via a parallel OF bus. In addition, the imaging elements 603 of the imaging device 601 is connected to the imaging controller 605 via a serial OF bus such as an inter-integrated circuit (I2C) bus or the like. Each of the image processor 604, the imaging controller 605, and the audio processor 609 is connected to the CPU 611 via a bus 610. The ROM 612, the SRAM 613, the DRAM 614, the operation device 615, the external device OF 616, the communication device 617, the audio sensor 618, and the like are also connected to the bus 610.

The image processor 604 obtains image data output from the imaging element 603 via the parallel OF bus and performs predetermined processing on the image data to generate data of a panoramic image and talker images from a fish-eye image. The image processor 604 combines the panoramic image, the talker images, and the like together to output a single video.

The imaging controller 605 usually serves as a master device, whereas the imaging element 603 usually serves as a slave device. The imaging controller 605 sets commands and the like in the group of registers of the imaging element 603 via the I2C bus. The imaging controller 605 receives the commands from the CPU 611. In addition, the image controller 605 obtains status data of the group of registers of the imaging element 603 via the I2C bus and transmits the status data to the CPU 611.

Further, the imaging controller 605 instructs the imaging element 603 to output image data at a timing when an imaging start button of the operation device 615 is pressed or a timing when the imaging controller 605 receives an instruction to start imaging from the CPU 611. In some cases, the meeting device 60 has functions that support a preview display function and a video display function to be implemented by a display (e.g., a display of a PC or a smartphone). In this case, the image data is consecutively output from the imaging element 603 at a predetermined frame rate (frames per minute).

Furthermore, as will be described later, the imaging controller 605 operates in cooperation with the CPU 611 to function as a synchronization controller that synchronizes the time when the imaging element 603 outputs the image data. In the present embodiment, the meeting device 60 does not include a display. However, in another embodiment, the meeting device 60 may include a display.

The microphones 608a to 608c convert audio into audio (signal) data. The audio processor 609 obtains the audio data output from each of the microphones 608a to 608c via OF buses, mixes (synthesizes) the audio data output from each of the microphones 608a to 608c, and performs predetermined processing on the synthesized audio data. The audio processor 609 also determines a direction of an audio source (talker) from a level of the audio (volume) input from each of the microphones 608a to 608c.

The CPU 611 controls entire operation of the meeting device 60 and executes necessary processing. The ROM 612 stores various programs for operating the meeting device 60. Each of the SRAM 613 and the DRAM 614 is a work memory and stores programs to be executed by the CPU 611, data being processed, and the like. In particular, the DRAM 614 stores image data being processed by the image processor 604 and processed data of an equirectangular projection image.

The operation device 615 collectively refers to various operation buttons such as the imaging start button. The user operates the operation device 615 to start capturing an image or recording. In addition, the user operates the operation device 615 to turn on or off the meeting device 60, to establish a connection for communication, and to input settings such as various imaging modes and imaging conditions.

The external device OF 616 is an interface for connection with various external devices. The external device in this case is, for example, a PC. The video data or image data stored in the DRAM 614 is transmitted to an external terminal apparatus or stored in an external recording medium via the external device OF 616.

The communication device 617 may communicate with a cloud server via the Internet using a wireless communication technology such as Wireless Fidelity (Wi-Fi) via an antenna 617a included in the meeting device 60 and transmit the video data or image data stored in the DRAM 614 to the cloud server. Further, the communication device 617 may be able to communicate with nearby devices using a short-range wireless communication technology such as BLUETOOTH LOW ENERGY (BLE) or the near field communication (NFC).

The audio sensor 618 is a sensor that obtains audio data in 360 degrees in order to identify the direction from which audio of high volume is input in the surroundings in 360 degrees (on a horizontal plane) around the meeting device 60. The audio processor 609 determines a direction in which the audio of the highest volume is input in the surroundings in 360 degrees based on a 360-degree audio parameter input in advance, and outputs the audio input from the determined direction.

Note that another sensor such as an azimuth and acceleration sensor or a global positioning system (GPS) sensor may be used to calculate an azimuth, a position, an angle, an acceleration, and the like for image correction or addition of position information.

The CPU 611 generates a panoramic image in the following method. The CPU 611 executes predetermined camera image processing such as Bayer interpolation (red green blue (RGB) supplementation processing) on raw data input by an image sensor that inputs a spherical image to generate a wide-angle image (a video including curved-surface images). Further, the CPU 611 executes unwrapping processing (distortion correction processing) on the wide-angle image (the video including curved-surface images) to generate a panoramic image (a video including planar images) of the surroundings in 360 degrees around the meeting device 60.

The CPU 611 generates a talker image in the following method. The CPU 611 generates a talker image on which a talker is cut out from a panoramic image (a video including planar images) of the surroundings in 360 degrees around the meeting device 60. The CPU 611 determines a direction of the input audio identified from the audio of the surroundings in 360 degrees using the audio sensor 618 and the audio processor 609 to be a direction of the talker, and cuts out a talker image from the panoramic image. At this time, a method of cutting out an image of a person based on the direction of the input audio is cutting out an image of, from 360 degrees, a 30-degree portion around the determined direction of the input audio and performing processing to detect a human face on the image of 30-degree portion. Thus, the image of the person is cut out. The CPU 611 further identifies talker images of a specific number of persons (e.g., three persons) who have most recently made utterances among the talker images cut out from the panoramic image.

The panoramic image and one or more talker images may be individually transmitted to the information recording application 41. Alternatively, the meeting device 60 may generate a single image combined from the panoramic image and the one or more talker images and transmit the single image to the information recording application 41. In the present embodiment, it is assumed that the panoramic image and the one or more talker images are individually transmitted from the meeting device 60 to the information recording application 41.

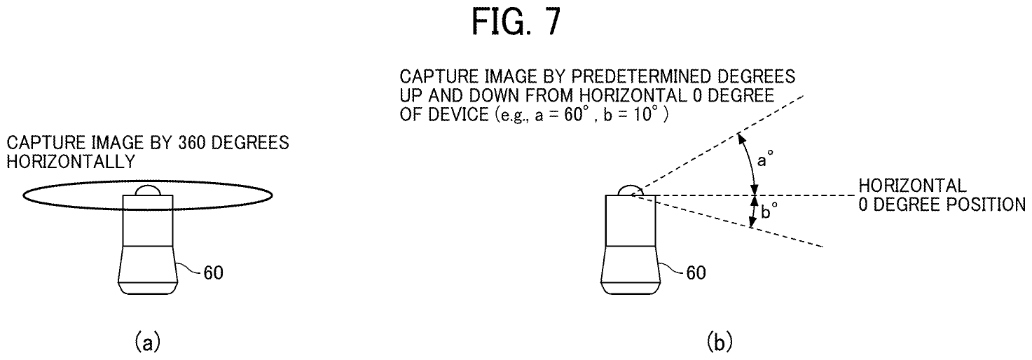

FIG. 7 is a schematic diagram illustrating an imaging range of the meeting device 60. As illustrated in part (a) of FIG. 7, the meeting device 60 captures an image of a range of 360 degrees in the horizontal direction. As illustrated in part (b) of FIG. 7, the meeting device 60 captures an image in predetermined angles up and down from a 0-degree direction that is horizontal to the height of the meeting device 60.

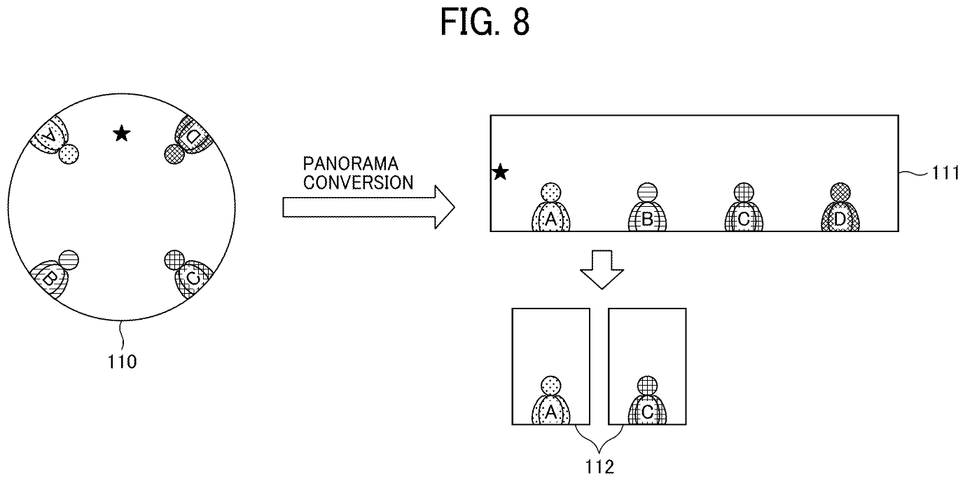

FIG. 8 is a schematic diagram illustrating a panoramic image and processing to cut out talker images from the panoramic image. As illustrated in FIG. 8, an image captured by the meeting device 60 forms a part 110 of a sphere, and thus has a three-dimensional shape. As illustrated in part (b) of FIG. 7, the meeting device 60 divides angles of view into the predetermined degrees up and down and by the predetermined angle in the horizontal direction to perform perspective projection conversion on each of the angles of view. The meeting device 60 performs the perspective projection conversion on the entire 360-degree range in the horizontal direction without gaps to obtain a predetermined number of planar images and laterally connects the predetermined number of the planar images to obtain a panoramic image 111. Further, the meeting device 60 performs the processing to detect a human face in a predetermined range centered around the direction of audio in the panoramic image, and cuts out images by 15 degrees each (30 degrees in total) to the left and right from the center of the human face to generate talker images 112.

Electronic Whiteboard

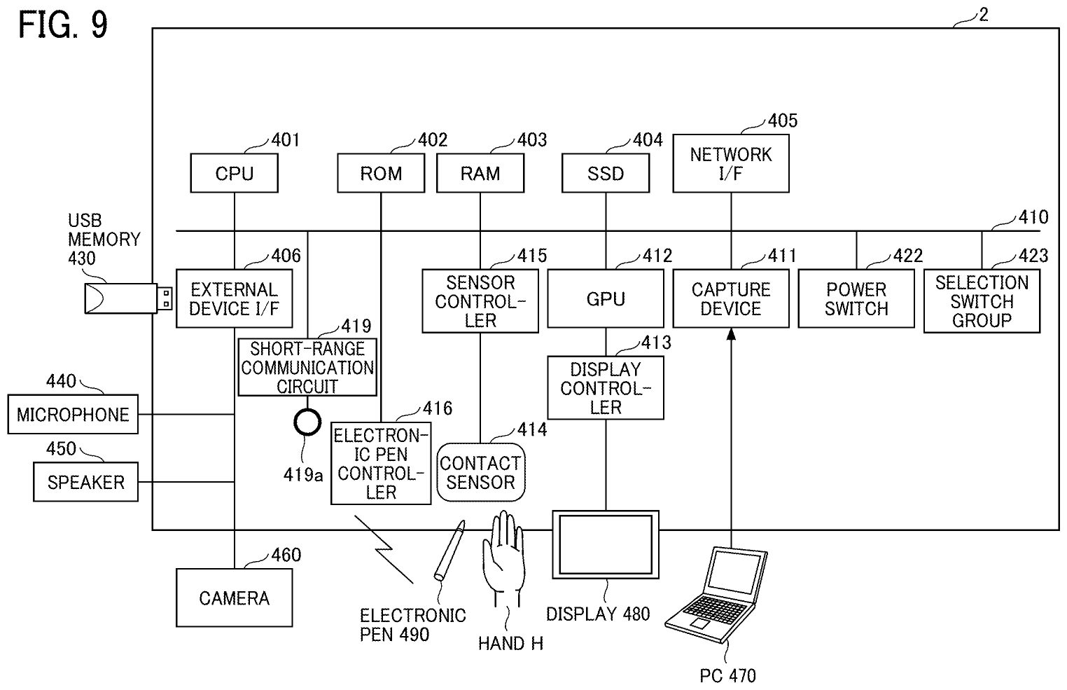

FIG. 9 is a block diagram illustrating a hardware configuration of the electronic whiteboard 2. As illustrated in FIG. 9, the electronic whiteboard 2 includes a CPU 401, a ROM 402, a RAM 403, a solid state drive (SSD) 404, a network OF 405, and an external device OF 406.

The CPU 401 controls entire operation of the electronic whiteboard 2. The ROM 402 stores a program such as an IPL to boot an operating system (OS). The RAM 403 is used as a work area for the CPU 401. The SSD 404 stores various data such as a control program for the electronic whiteboard 2. The network OF 405 controls communication with a communication network. The external device OF 406 is an interface for connection with various external devices. Examples of the external devices in this case include, but are not limited to, a USB memory 430 and external devices (a microphone 440, a speaker 450, and a camera 460).

The electronic whiteboard 2 further includes a capture device 411, a graphics processing unit (GPU) 412, a display controller 413, a contact sensor 414, a sensor controller 415, an electronic pen controller 416, a short-range communication circuit 419, an antenna 419a of the short-range communication circuit 419, a power switch 422, and a selection switch group 423.

The capture device 411 acquires display information of an external PC 470 to display a still image or a video based on the display information. The GPU 412 is a semiconductor chip dedicated to processing of a graphical image. The display controller 413 controls screen display to output an image processed by the GPU 412 to a display 480. The contact sensor 414 detects a touch onto the display 480 with an electronic pen 490 or a user's hand H. The sensor controller 415 controls processing of the contact sensor 414. The contact sensor 414 receives a touch input and detects coordinates of the touch input according to the infrared blocking system. More specifically, for inputting and detecting the coordinates, the display 480 is provided with two light receiving and emitting devices disposed at both ends of the upper face of the display 480, and a reflector frame surrounding the periphery of the display 480. The light receiving and emitting devices emit a plurality of infrared rays in parallel to a surface of the display 480. The plurality of infrared rays are reflected by the reflector frame, and a light-receiving element receives light returning through the same optical path of the emitted infrared rays. The contact sensor 414 outputs, to the sensor controller 415, position information (a position on the light-receiving element) of the infrared ray that is emitted from the two light receiving and emitting devices and then blocked by an object. Based on the position information of the infrared ray, the sensor controller 415 detects specific coordinates of the position touched by the object. The electronic pen controller 416 communicates with the electronic pen 490 by BLUETOOTH to detect a touch by the tip or bottom of the electronic pen 490 to the display 480. The short-range communication circuit 419 is a communication circuit in compliance with the NFC, BLUETOOTH, or the like. The power switch 422 is a switch that turns on or off the power of the electronic whiteboard 2. The selection switch group 423 is a group of switches for adjusting brightness, hue, etc., of display on the display 480, for example.

The electronic whiteboard 2 further includes a bus line 410. The bus line 410 is an address bus or a data bus, which electrically connects each component illustrated in FIG. 9 such as the CPU 401.

Note that the contact sensor 414 is not limited to a touch sensor of the infrared blocking system, and may be a capacitive touch panel that detects a change in capacitance to identify a contact position. Alternatively, the contact sensor 414 may be a resistance film touch panel that detects a change in voltage of two opposing resistance films to identify a contact position. Further, the contact sensor 414 may be an electromagnetic inductive touch panel that detects electromagnetic induction caused by contact of an object to the display to identify a contact position. In addition to the devices described above, various other types of detection devices may be used as the contact sensor 414. In addition to or alternative to detecting a touch by the tip or bottom of the electronic pen 490, the electronic pen controller 416 may also detect a touch by another part of the electronic pen 490, such as a part held by a hand of a user.

Functions

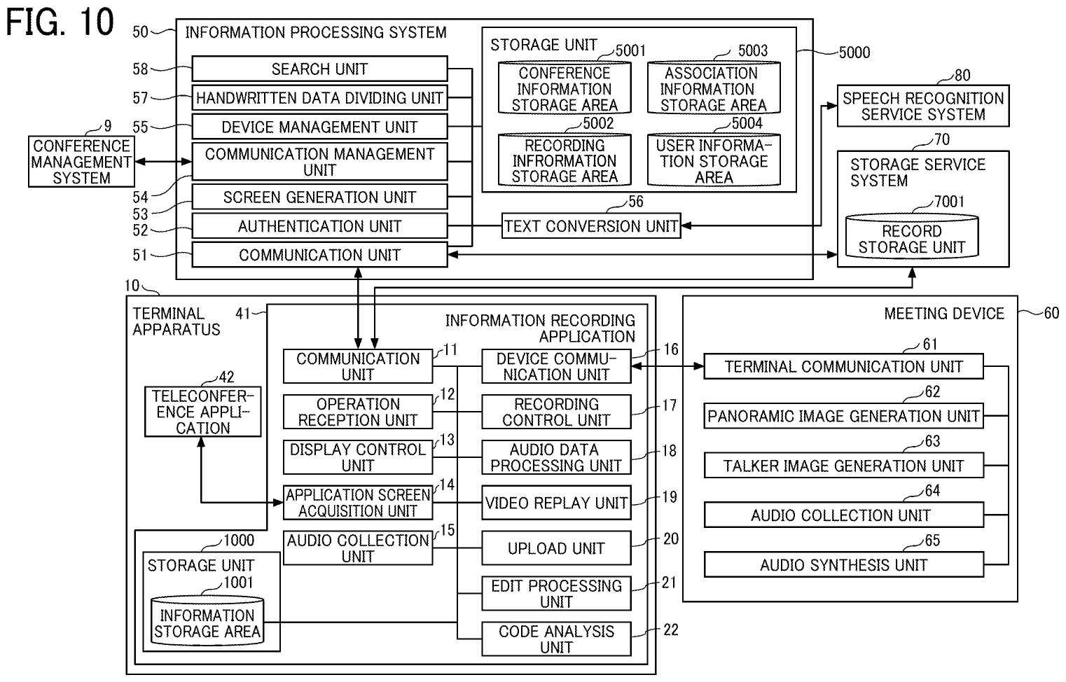

With reference to FIG. 10, a functional configuration of the record creation system 100 is described. FIG. 10 is a block diagram illustrating an example of functional configurations of the terminal apparatus 10, the meeting device 60, and the information processing system 50 in the record creation system 100.

Terminal Apparatus

The information recording application 41 operating on the terminal apparatus 10 implements a communication unit 11, an operation reception unit 12, a display control unit 13, an application screen acquisition unit 14, an audio collection unit 15, a device communication unit 16, a recording control unit 17, an audio data processing unit 18, a video replay unit 19, an upload unit 20, an edit processing unit 21, and a code analysis unit 22. These units of functions included in the terminal apparatus 10 are implemented by or caused to function by one or more of the hardware components illustrated in FIG. 5 operating in accordance with instructions from the CPU 501 according to the information recording application 41 loaded from the HD 504 to the RAM 503. The terminal apparatus 10 further includes a storage unit 1000 implemented by the HD 504 illustrated in FIG. 5. The storage unit 1000 includes an information storage area 1001, which is implemented by a database, for example.

The communication unit 11 transmits and receives various kinds of information to and from the information processing system 50 via a communication network. For example, the communication unit 11 receives a list of teleconferences from the information processing system 50, and transmits a request of speech recognition on audio data to the information processing system 50.

The display control unit 13 displays various screens serving as user interfaces in the information recording application 41 in accordance with screen transitions set in the information recording application 41. The operation reception unit 12 receives various operations input to the information recording application 41.

The application screen acquisition unit 14 acquires, from the OS or the like, a desktop screen or a screen displayed by an application selected by the user. In a case where the application selected by the user is the teleconference application 42, a screen (including e.g., an image of each site and an image of a material or document displayed) generated by the teleconference application 42 is obtained.

The audio collection unit 15 acquires the audio data received by the teleconference application 42 in the teleconference from the teleconference application 42. Note that the audio data acquired by the audio collection unit 15 does not include audio data collected by the terminal apparatus 10, but includes only the audio data received in the teleconference through the teleconference application 42. This is because the meeting device 60 separately collects audio.

The device communication unit 16 communicates with the meeting device 60 using a USB cable or the like. Alternatively, the device communication unit 16 may use a wireless local area network (LAN) or BLUETOOTH to communicate with the meeting device 60. The device communication unit 16 receives the panoramic image and the talker images from the meeting device 60, and transmits the audio data acquired by the audio collection unit 15 to the meeting device 60. The device communication unit 16 receives the audio data synthesized by the meeting device 60.

The recording control unit 17 combines the panoramic image and the talker images received by the device communication unit 16 and the application screen acquired by the application screen acquisition unit 14 to generate a composite image. In addition, the recording control unit 17 connects, in time series, composite images that are repeatedly generated by the recording control unit 17 to generate a composite image video, and further attaches the audio data synthesized by the meeting device 60 to the composite image video to generate a composite image video with audio.

The audio data processing unit 18 requests the information processing system 50 to convert, into text data, the audio data extracted by the recording control unit 17 from the composite image video with audio or the synthesized audio data received from the meeting device 60.

The video replay unit 19 replays the composite image video. The composite image video is stored in the terminal apparatus 10 during recording, and then uploaded to the information processing system 50.

After the teleconference ends, the upload unit 20 transmits the composite image video to the information processing system 50.

The edit processing unit 21 performs editing (e.g., deleting a part, connecting parts) of the composite image video according to a user operation.

The code analysis unit 22 detects a two-dimensional code included in the panoramic image and analyzes the two-dimensional code to acquire a device identifier.

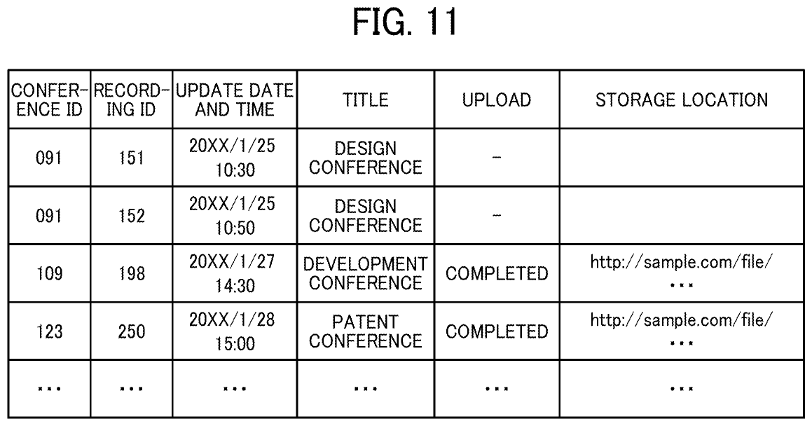

FIG. 11 is a diagram illustrating an example of data structure of information on a recorded video stored in the information storage area 1001. The information on a recorded video includes, as data items, “CONFERENCE ID,” “RECORDING ID,” “UPDATE DATE AND TIME,” “TITLE,” “UPLOAD,” and “STORAGE LOCATION.” When the user logs in to the information processing system 50, the information recording application 41 downloads conference information from a conference information storage area 5001 included in the information processing system 50. The conference ID included in the conference information is reflected in the information on a recorded video. The information on a recorded video illustrated in FIG. 11 is stored by the terminal apparatus 10 operated by a certain user.

The item “CONFERENCE ID” is identification information that identifies a teleconference that has been held. The conference ID is assigned when a schedule of the teleconference is registered in a conference management system 9, or is assigned by the information processing system 50 in response to a request from the information recording application 41.

The item “RECORDING ID” is identification information that identifies a composite image video recorded in the teleconference. The recording ID is assigned by the meeting device 60. Alternatively, the recording ID may be assigned by the information recording application 41 or the information processing system 50. Different pieces of the recording ID are assigned for the same conference ID in a case where the recording is suspended in the middle of the teleconference but is started again for some reason.

The item “UPDATE DATE AND TIME” is a date and time when a composite image video is updated (or recording is ended). In a case where the composite image video is edited, the update date and time indicates the date and time of editing.

The item “TITLE” is a name of a conference (or a teleconference). The title may be set when the schedule of the conference is registered in the conference management system 9, or may be freely set by the user.

The item “UPLOAD” indicates whether a composite image video has been uploaded to the information processing system 50.

The item “STORAGE LOCATION” indicates a location, such as a uniform resource locator (URL) or a file path, where the composite image video, text data, and object information are stored in the storage service system 70. Accordingly, the storage location allows the user to browse the composite image video uploaded to the information processing system 50 as desired. Note that the composite image video and the text data are stored with different file names, for example, following the same URL.

Meeting Device

Returning to FIG. 10, the description continues. The meeting device 60 includes a terminal communication unit 61, a panoramic image generation unit 62, a talker image generation unit 63, an audio collection unit 64, and an audio synthesis unit 65. These functional units of the meeting device 60 are implemented by or caused to function by one or more of the hardware components illustrated in FIG. 6 operating in accordance with instructions from the CPU 611 according to the control program loaded from the ROM 612 to the DRAM 614.

The terminal communication unit 61 communicates with the terminal apparatus 10 using a USB cable or the like. The connection of the terminal communication unit 61 to the terminal apparatus 10 is not limited to a wired cable, but includes connection by a wireless LAN, BLUETOOTH, or the like.

The panoramic image generation unit 62 generates a panoramic image. The talker image generation unit 63 generates a talker image. The methods of generating the panoramic image and the talker image have been already described with reference to FIGS. 7 and 8.

The audio collection unit 64 converts audio received by a microphone of the meeting device 60 into audio data (digital data). Accordingly, the utterances (speeches) made by the user and the participants at the site where the terminal apparatus 10 is located are collected.

The audio synthesis unit 65 synthesizes the audio transmitted from the terminal apparatus 10 and the audio collected by the audio collection unit 64. Accordingly, the audio of utterances made at the other site 101 and the audio of utterances made at the own site 102 are synthesized.

Information Processing System

The information processing system 50 includes a communication unit 51, an authentication unit 52, a screen generation unit 53, a communication management unit 54, a device management unit 55, a text conversion unit 56, a handwritten data dividing unit 57, and a search unit 58. These functional units of the information processing system 50 are implemented by or caused to function by one or more of the hardware components illustrated in FIG. 5 operating in accordance with instructions from the CPU 501 according to the control program loaded from the HD 504 to the RAM 503. The information processing system 50 further includes a storage unit 5000 implemented by the HD 504 illustrated in FIG. 5. The storage unit 5000 includes the conference information storage area 5001, a recording information storage area 5002, an association information storage area 5003, and a user information storage area 5004 each of which is implemented by a database, for example.

The communication unit 51 transmits and receives various kinds of information to and from the terminal apparatus 10 via a communication network. The communication unit 51, for example, transmits a list of teleconferences to the terminal apparatus 10 and receives a request of speech recognition on audio data from the terminal apparatus 10.

The authentication unit 52 authenticates a user who operates the terminal apparatus 10. For example, the authentication unit 52 authenticates a user based on whether authentication information (user ID and a password) included in an authentication request received by the communication unit 51 matches authentication information stored in advance. Alternatively, a card number of an integrated circuit (IC) card, biometric authentication information such as a face or a fingerprint, or the like may be used as the authentication information. Further, the authentication unit 52 may use an external authentication system or an authentication method such as an open authentication standard (OAuth) to authenticate a user.

The screen generation unit 53 provides screen information representing a screen to be displayed by the information recording application 41. Since the information recording application 41 has a structure of the screen, the screen generation unit 53 provides the terminal apparatus 10 with a heat map, an activity level, and the like in a format of Extensible Markup Language (XML) or the like. When the terminal apparatus 10 executes a web application, the screen generation unit 53 generates screen information representing a screen to be displayed by the web application. The screen information is described in Hyper Text Markup Language (HTML), XML, Cascade Style Sheet (CSS), or JAVASCRIPT, for example.

The communication management unit 54 acquires information relating to a teleconference from the conference management system 9 using an account of each user or a system account assigned by the information processing system 50. The communication management unit 54 stores conference information of a scheduled conference in association with the conference ID in the conference information storage area 5001. In addition, the communication management unit 54 acquires conference information for which a user belonging to a tenant has a right to browse. Since the conference ID is set for a conference, the teleconference and the record are associated with each other by the conference ID.

In response to receiving device identifiers of the electronic whiteboard 2 and the meeting device 60 to be used in the conference, the device management unit 55 stores these device identifiers in the association information storage area 5003 in association with the teleconference. Accordingly, the conference ID, the device identifier of the electronic whiteboard 2, and the device identifier of the meeting device 60 are associated with each other. Since the composite image video is also associated with the conference ID, the handwritten data input on the electronic whiteboard 2 and the composite image video are also associated with each other by the conference ID. When recording ends (when the conference ends), the device management unit 55 deletes the association from the association information storage area 5003.

The text conversion unit 56 uses an external service system such as the speech recognition service system 80 to convert, into text data, audio data requested to be converted into text data by the terminal apparatus 10. Alternatively, the text conversion unit 56 may perform the text conversion without using the external service system.

The handwritten data dividing unit 57 divides the handwritten data transmitted from the electronic whiteboard 2 into a group of pieces of stroke data defined by a time interval due to interruption of handwriting, to obtain the resultant as one piece of handwritten data. In the present embodiment, writer ID is associated with the handwritten data. In addition, one piece of handwritten data is stored in one file (e.g., a portable document format (PDF) file) so that the file can be provided at a time of retrieval. Note that the handwritten data may be divided according to separation only by distance between positions where handwritings are input, or may be divided according to separation by both time and distance.

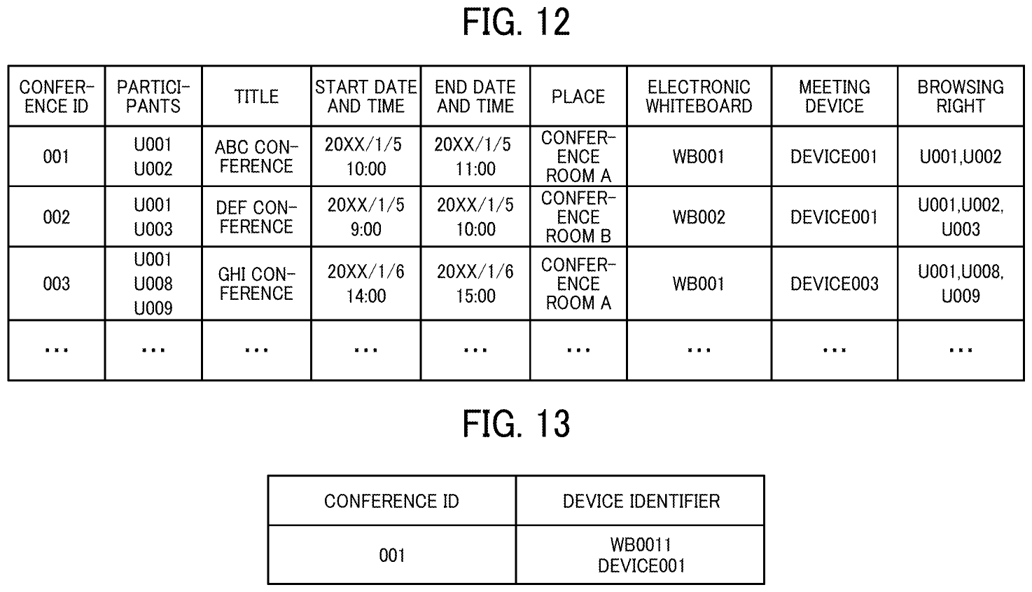

FIG. 12 is a diagram illustrating an example of data structure of conference information stored in the conference information storage area 5001 and managed by the communication management unit 54. The communication management unit 54 uses the above-described account to acquire a list of teleconferences for which a user belonging to a tenant has a right to browse. In the present embodiment, teleconferences are used as an example. However, the list of teleconferences also includes conferences each of which is held in a single conference room.

The conference information is managed with the conference ID, which is associated with the items “PARTICIPANTS,” “TITLE,” “START DATE AND TIME,” “END DATE AND TIME,” “PLACE,” and the like. These items are an example of the data structure of the conference information, and the conference information may include other items.

The item “PARTICIPANTS” are participants of the conference.

The item “TITLE” represents a content of the conference such as a name of the conference or an agenda of the conference.

The item “START DATE AND TIME” is the date and time when the conference is scheduled to be started.

The item “END DATE AND TIME” is the date and time when the conference is scheduled to be ended.

The item “PLACE” represents a place where the conference is held such as a name of a conference room, a name of a branch office, or a name of a building.

The item “ELECTRONIC WHITEBOARD” represents a device identifier of the electronic whiteboard 2 used in the conference.

The item “MEETING DEVICE” represents a device identifier of the meeting device 60 used in the conference.

The item “BROWSING RIGHT” represents user ID registered, when an organizer of the conference registers the conference information in advance or after the conference is held, as a user having a right to browse information on the conference. For example, for each conference, only names of participants, names of participants and any user names of the participants, or any user names of participants are registered in the conference information. In a case where a person other than the registered users performs a search, the search unit 58 does not provide a search result regarding the record and the object information of the conference even when the search result is obtained by the search.

As illustrated in FIGS. 11 and 12, the composite image video recorded in a conference is identified with the conference ID.

Recording information stored in the recording information storage area 5002 may be the same as the information on a recorded video illustrated in FIG. 11. Note that the information processing system 50 has a list of composite image videos recorded by all users belonging to the tenant.

FIG. 13 is a diagram illustrating an example of data structure of association information associating the device identifiers of the electronic whiteboard 2 and the meeting device 60 with conference ID each other. The association information is stored in the association information storage area 5003. The association information is kept stored from when the information recording application 41 transmits the device identifiers to the information processing system 50 to when the recording ends.

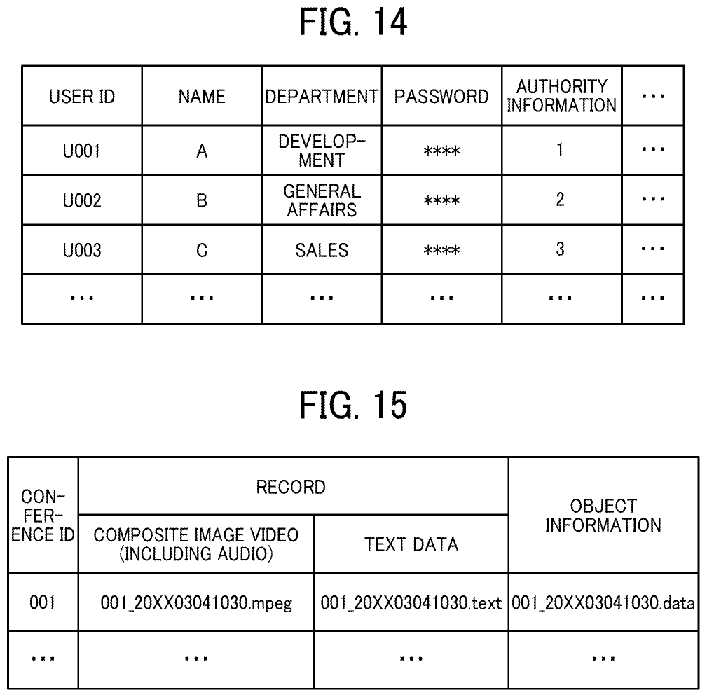

FIG. 14 is a diagram illustrating an example of data structure of user information stored in the user information storage area 5004. In the user information storage area 5004, as data items, “USER ID,” “NAME,” “DEPARTMENT,” “PASSWORD,” “AUTHORITY INFORMATION,” and the like are stored in association with each other. The item “USER ID” represents identification information that identifies, for example, an employee. The item “NAME” represents a name or nickname of a user. The item “DEPARTMENT” represents a department to which the user belongs. The item “PASSWORD” represents a character string that is compared with a password input by the user at logging in. The item “AUTHORITY INFORMATION” indicates various authorities related to the user. At a time of searching for a record or object information, the authority information serves as information of the browsing right. The greater the numeric value of the authority information is, the stronger the authority is. For example, the information processing system 50 can be controlled not to provide a search result unless the numeric value of the authority information of a user who is a searcher is greater than or equal to the numeric value of the authority information of the user attached to handwritten data or text data.

Storage Service System

The storage service system 70 may be any service system that stores a record and object information. In the record storage unit 7001, a record (a composite image video, text data) and object information are stored.

FIG. 15 is a diagram illustrating an example of data structure of a record and object information stored in the record storage unit 7001. As illustrated in FIG. 15, a composite image video and text data that are parts of a record and object information are stored in association with conference ID. The composite image video includes synthesized audio. The text data is obtained by converting the synthesized audio data through speech recognition. The object information is information relating to an object such as handwritten data input to the electronic whiteboard 2, which will be described later. Since the record and the object information are associated with the conference ID, the record and the object information are also associated with the conference information.

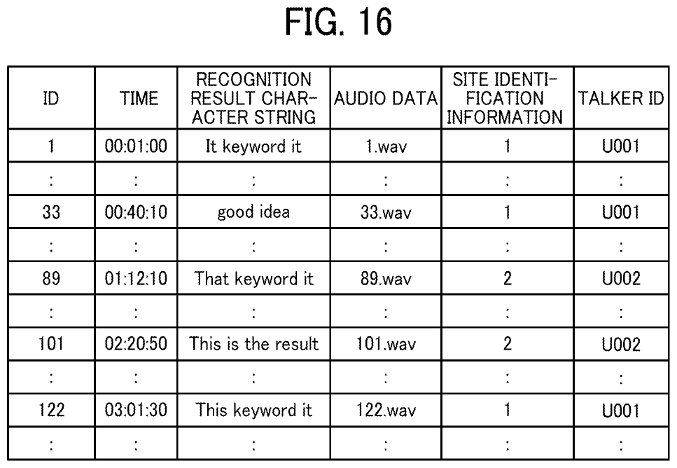

FIG. 16 is a diagram illustrating an example of data structure of text data which is a part of a record. As illustrated in FIG. 16, in the text data, items of “ID,” “TIME,” “RECOGNITION RESULT CHARACTER STRING,” “AUDIO DATA,” “SITE IDENTIFICATION INFORMATION,” and “TALKER ID” are associated with each other, for example, in a database in a table format.

The item “ID” represents identification information that is assigned in a case where audio at the own site and audio at the other site are divided according to a predetermined rule. The predetermined rule is set in the meeting device 60 (or at least one of the meeting device and the speech recognition service system 80). For example, the rule specifies dividing the audio when a silence continues for a certain period of time, dividing the audio by elapse of a certain period of time regardless of presence of silence, or dividing the audio by units of sentence detected by morphological analysis.

The item “TIME” represents a time elapsed from the start of recording when an utterance is made. Since the so-called time of day is also recorded at the start of recording, the time (absolute time) when the utterance converted into the text is made is also known.

The item “RECOGNITION RESULT CHARACTER STRING” is a part of text data obtained by converting, through speech recognition, the synthesized audio data already divided according to the predetermined rule. The synthesized audio data is the audio data that is a source from which the recognition result character string is converted.

The item “AUDIO DATA” is synthesized audio data that is obtained by synthesizing the audio at the own site and the audio at the other site after the determination of the site is performed and has already been divided according to the predetermined rule.

The item “SITE IDENTIFICATION INFORMATION” is identification information that identifies a site where the utterance represented by the audio data is made. The site is determined based on the sound pressure of the audio at the own site and the sound pressure of the audio at the other site. As for the site identification information, for example, a numeric value “1” represents the own site, and a numeric value “2” represents the other site.

The item “TALKER ID” represents user ID indicating a talker who has made the utterance of the recognition result character string. The participant who has made the utterance is also identified by the user ID. Several methods are known for identifying a talker at a conference. For example, one of the methods is using a voiceprint. A voiceprint that is registered by each employee in advance is used for identifying a talker. Another one of the methods is using face recognition. Since the meeting device 60 detects a direction of a talker, the talker can be identified by performing face recognition on a participant located in the direction. Any method that can identify a talker may be used. In a venue where microphones are prepared for individual talkers, a talker is identified by specifying a microphone that collects the audio.

As described above, the text data (recognition result character string in this example) is associated with the talker ID. Accordingly, in a case where the text data is searched for by a name of a participant, the search unit 58 searches for the talker ID of the participant and specifies the text data of the utterance made by the participant.

Electronic Whiteboard

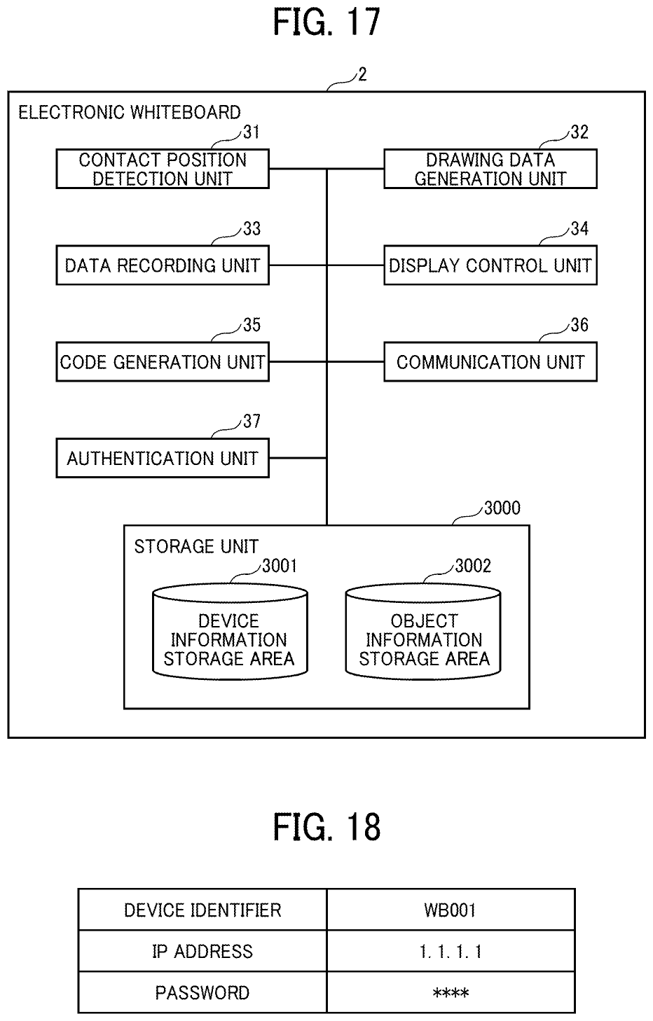

FIG. 17 is a block diagram illustrating functional configurations of the electronic whiteboard 2. The electronic whiteboard 2 includes a contact position detection unit 31, a drawing data generation unit 32, a data recording unit 33, a display control unit 34, a code generation unit 35, a communication unit 36, and an authentication unit 37. These units of functions included in the electronic whiteboard 2 are implemented by or caused to function by one or more of the hardware components illustrated in FIG. 9 operating in accordance with instructions from the CPU 401 according to the control program loaded from the SSD 404 to the RAM 403.

The contact position detection unit 31 detects coordinates of a position where the electronic pen 490 has touched the contact sensor 414. The drawing data generation unit 32 acquires the coordinates of the position touched by the tip of the electronic pen 490 from the contact position detection unit 31. The drawing data generation unit 32 connects a plurality of contact coordinates into a coordinate point sequence by interpolation, to generate stroke data.

The display control unit 34 displays handwritten data, a menu to be operated by the user, and the like on the display.

The data recording unit 33 stores, in an object information storage area 3002, handwritten data drawn on the electronic whiteboard 2, a graphic such as a circle or triangle, a stamp indicating completion or the like, a screen of a PC, and a file. Each of the handwritten data, the graphic, an image such as the screen of the PC, and the file is treated as an object.

The communication unit 36 is connected to Wi-Fi or a LAN, and communicates with the information processing system 50. The communication unit 36 transmits object information to the information processing system 50, receives object information stored in the information processing system 50 from the information processing system 50, and displays an object based on the object information on the display 480.

The code generation unit 35 encodes the device identifier of the electronic whiteboard 2 stored in a device information storage area 3001 and information indicating that the device is usable in the conference into a two-dimensional pattern, to generate a two-dimensional code. The code generation unit 35 may encode, into a barcode, the device identifier of the electronic whiteboard 2 and the information indicating that the device is usable in the conference. The device identifier is, for example, either a serial number or a universally unique identifier of the electronic whiteboard 2. Alternatively, the device identifier may be set by the user.

The authentication unit 37 authenticates a user of the electronic whiteboard 2. The authentication method performed by the authentication unit 37 may be the same as that of the authentication unit 52. Alternatively, the authentication unit 37 may request the authentication unit 52 to perform authentication.

In addition, the electronic whiteboard 2 includes a storage unit 3000 implemented by the SSD 404 illustrated in FIG. 9. The storage unit 3000 includes the device information storage area 3001 and the object information storage area 3002 each of which is implemented by a database, for example.

FIG. 18 is a diagram illustrating data structure of device identification information stored in the device information storage area 3001. The item “DEVICE IDENTIFIER” represents identification information that identifies the electronic whiteboard 2. The item “IP ADDRESS” represents an IP address used by another device to connect to the electronic whiteboard 2 via a network. The item “PASSWORD” represents a character string used for authentication performed when another apparatus connects to the electronic whiteboard 2.

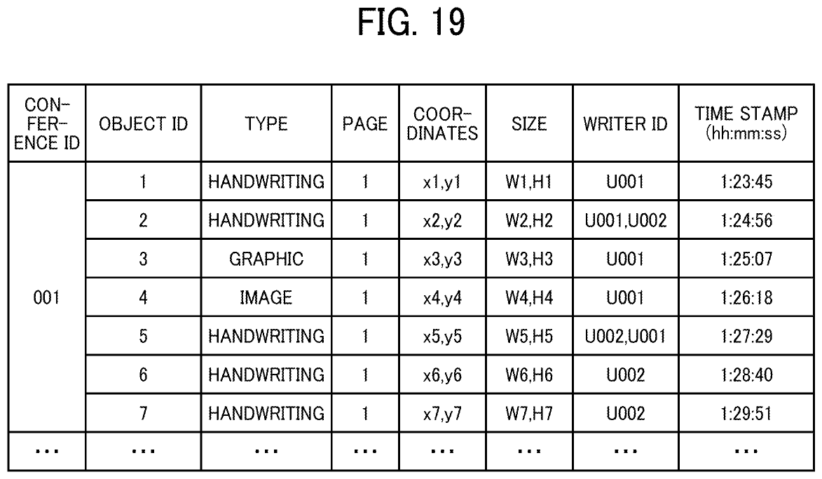

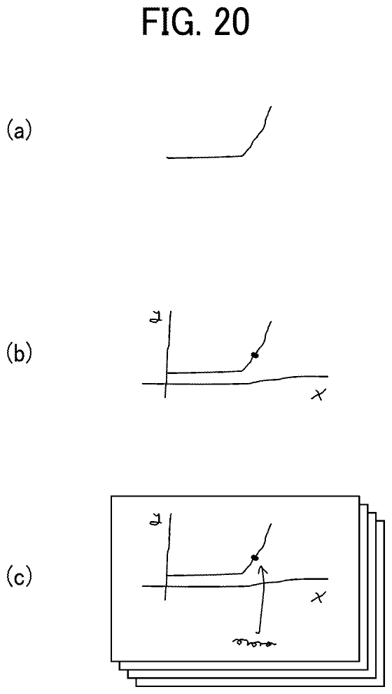

FIG. 19 is a diagram illustrating data structure of object information stored in the object information storage area 3002. The object information is information used for managing an object displayed by the electronic whiteboard 2. The object information is transmitted to the information processing system 50 and used in minutes. In a case where the electronic whiteboard 2 is located at another site when the teleconference is held, the object information is shared with the own site.

In the item “CONFERENCE ID,” identification information of a conference notified from the information processing system 50 is set.

In the item “OBJECT ID,” identification information for identifying an object is set.

In the item “TYPE,” a type of object is set. Examples of the type of object are “HANDWRITING,” “GRAPHIC,” and “IMAGE.” The type “HANDWRITING” represents stroke data (coordinate point sequence). The type “GRAPHIC” represents a geometric shape such as a triangle or a quadrangle. The type “IMAGE” represents image data in a format such as Joint Photographic Experts Group (JPEG), Portable Network Graphics (PNG), or Tagged Image File Format (TIFF) acquired from, for example, a PC or the Internet. The data body of each of the objects is stored in association with the object ID. The handwritten data may be converted into text by character recognition.

A single screen of the electronic whiteboard 2 is referred to as a page. The item “PAGE” indicates the page number.

In the item “COORDINATES,” a position of an object with reference to a predetermined origin on the screen of the electronic whiteboard 2 is set. The position of the object is, for example, the upper left vertex of a circumscribed rectangle of the object. The coordinates are expressed, for example, in units of pixels of a display.

In the item “SIZE,” a width and a height of the circumscribed rectangle of the object are set.

The item “WRITER ID” represents user ID of a user who inputs the object. The user logs in to the electronic whiteboard 2 before starting to use the electronic whiteboard 2. The user ID of the user is identified by logging in. For example, in a case where only one user inputs information to the electronic whiteboard 2 at the same time, the user ID of the user who logs in last is associated with the object. In a case where a plurality of users input information to the electronic whiteboard 2 at the same time, the electronic pens and the user ID are preferably associated with each other. For example, the ID of the electronic pen and the user ID are associated with each other in the order in which the user logs in. Thereby, the user ID of the user who inputs the object is identified by the electronic pen used by the user for input. A plurality of pieces of user ID is registered in the item of the writer ID since one piece of handwritten data has a plurality of strokes, each of which is drawn by a different user. Although the writer ID is assigned by the information processing system 50 in the present embodiment, the writer ID is illustrated in FIG. 19 for convenience of description. Alternatively, the electronic whiteboard 2 may assign the writer ID.

As for the handwritten data associated with the plurality of pieces of user ID, in a case where at least one of the plurality of pieces of user ID matches the search condition, the handwritten data is provided.

In the item “TIME STAMP,” a time (an example of time information) when the input of the object is started is set. Alternatively, the time stamp may indicate a time when the input of the object is finished. As will be described with reference to FIG. 22, the time stamp of the handwritten data indicates a time when the first stroke or the last stroke is input in a case where the handwritten data is divided by the time between strokes. The time stamp may be either an absolute time or an elapsed time from the start of the conference (from power-on of the display device).

Relationship among Strokes, Handwritten Data, and Handwritten Material

FIG. 20 is a diagram illustrating a relationship among strokes, handwritten data, and handwritten material. Part (a) of FIG. 20 is a diagram illustrating an example of a stroke. Part (b) of FIG. 20 is a diagram illustrating an example of handwritten data. The handwritten data is a group of one or more strokes. Part (c) of FIG. 20 is a diagram illustrating an example of handwritten material. The handwritten material has one or more pieces of handwritten data. As illustrated in FIG. 20, the handwritten data is a group of a plurality of strokes that has some meaning. The handwritten material is formed of one or more pieces of handwritten data. The handwritten material is a group of handwritten data.

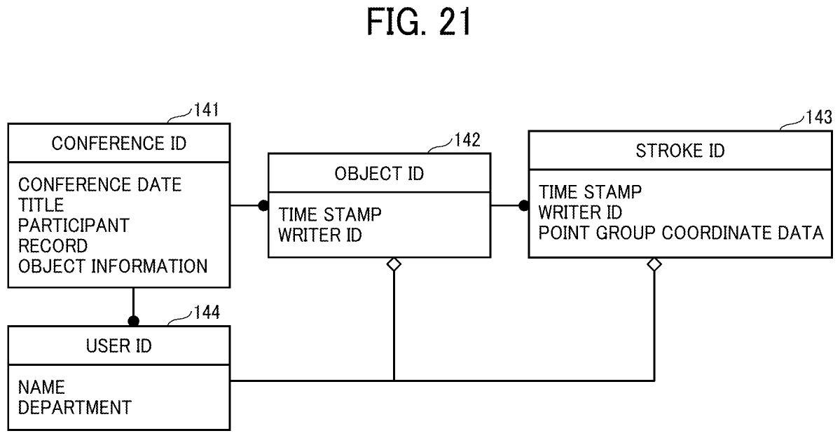

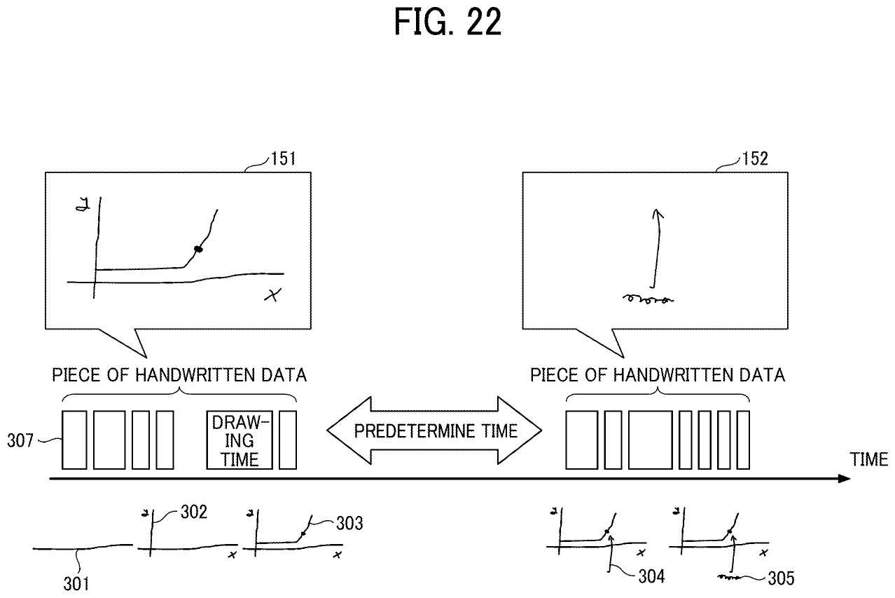

FIG. 21 is a diagram illustrating association among conference information 141, handwritten data 142, stroke data 143, and user information 144. As illustrated in FIG. 21, object information (including the handwritten data) is associated with the conference information 141. The handwritten data 142 is associated with individual pieces of the stroke data 143 that form the handwritten data 142. In each individual piece of the stroke data 143, a time stamp, writer ID, and point group coordinate data are associated with each other. The writer ID is associated with the user information 144.

Creation of Handwritten Data

In the present embodiment, the handwritten data is a group of one or more strokes that have some meaning. This is because it is difficult to grasp what is written even if each individual stroke is displayed as a search result. Displaying, as a search result, the group of one or more strokes having some meaning allows to grasp what is written. The handwritten data may be referred to as a group of a plurality of strokes that have some meaning.

FIG. 22 is a diagram illustrating a method of dividing handwritten data. As a method of dividing handwritten data, there is a method focusing on a time interval between a time when one stroke data is input and when a time another stroke data is input. This method is based on assumption that strokes successively handwritten make up handwritten data that has some meaning. The handwritten data dividing unit 57 separates, as other handwritten data, strokes handwritten after a lapse of time equal to or greater than a threshold value predetermined by a designer in advance.

In FIG. 22, time periods spent in handwriting strokes are indicated by quadrangles 307 along the time axis. An interval between a quadrangle 307 and another quadrangle 307 is a time period during which the electronic pen is not in contact with the electronic whiteboard 2 (a time period from disengagement to engagement of an electronic pen). A stroke 301, a stroke 302, a stroke 303, a stroke 304, and a stroke 305 are added in relation to time. It is assumed that the interval from when the electronic pen is disengaged after inputting the stroke 303 to when the electronic pen is engaged for inputting the stroke 304 is equal to or greater than the threshold value. In this case, the handwritten data dividing unit 57 records the stroke 301, the stroke 302, and the stroke 303 as one piece of handwritten data 151 and records the stroke 304 and the stroke 305 as another one piece of handwritten data 152.

The time period from disengagement to engagement of the electronic pen is used for dividing the strokes since there is a case where a single object is drawn by a plurality of persons in a conference. When strokes are extracted for each individual person from the object drawn by the plurality of persons by simply using user ID, for example, it may be difficult to grasp what is written with the strokes handwritten by each individual person because the strokes of the other persons are premised.

Display of Composite Image Video

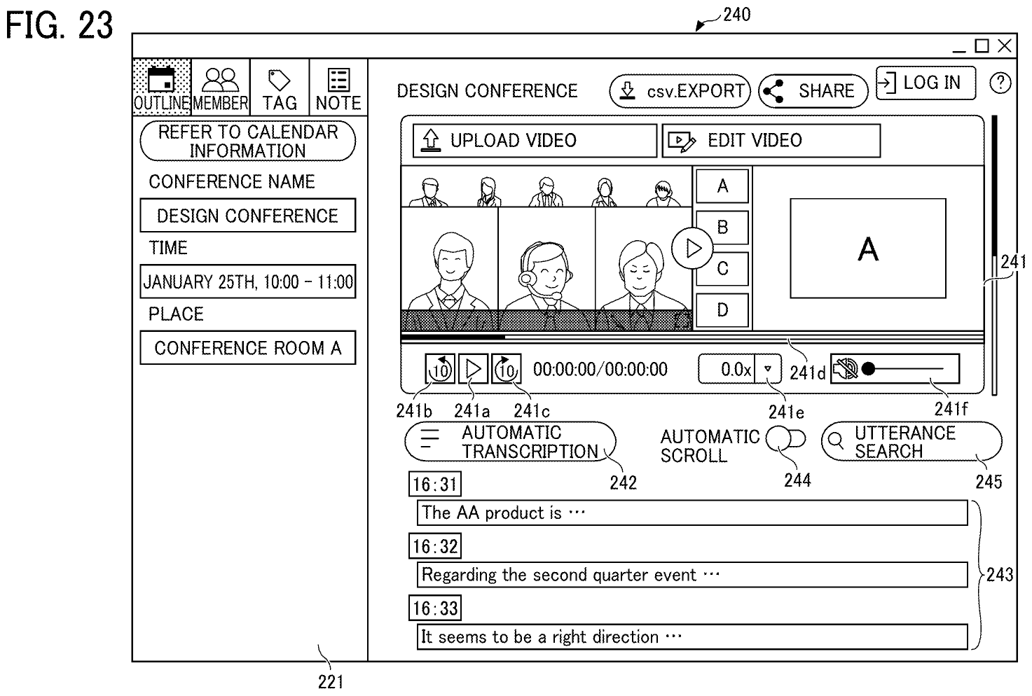

FIG. 23 is a diagram illustrating an example of a composite image video display screen 240 displayed by the information recording application 41. Note that the composite image video display screen 240 is a screen displayed after the end of the conference, but the screen displayed during the conference is almost the same. The composite image video display screen 240 includes a conference bibliographic information field 221, an image display field 241, a transcription button 242, one or more text display fields 243, an automatic scroll button 244, and a search button 245.

The conference bibliographic information field 221 is a field in which at least a part of conference information is displayed. In FIG. 23, a name of a conference, a time when the conference is held, and a place where the conference is held are displayed in the conference bibliographic information field 221.

The image display field 241 includes a replay button 241a, a rewind button 241b, a fast forward button 241c, a time indicator 241d, a display speed button 241e, a volume button 241f, and the like. In the image display field 241, the composite image video is displayed. In the composite image video in the image display field 241 of FIG. 23, the panoramic image and the talker images are arranged on the left side, and the screen of the teleconference application 42 is displayed on the right side. The screen of the teleconference application 42 can be switched between an image representing the site and an image of a material during the teleconference. Thus, the user can browse a screen of a desired scene by operating various buttons.

When the audio data of the composite image video being displayed in the image display field 241 has been converted into text data, a content of an utterance is displayed in text in the text display fields 243. Text data obtained by converting the synthesized audio data through speech recognition is displayed in the text display field 243.

The transcription button 242 is a button that allows the user to switch whether to display the text data in the text display fields 243 corresponding to the display time of the composite image video.

The automatic scroll button 244 is a button that allows the user to switch whether to automatically scroll the text data irrespective of the display time.

The search button 245 is a button that allows the user to designate a keyword and search for text data using the keyword. The search button 245 is a button for searching for only text data attached to the composite image video being displayed, and is different from the search described in the present embodiment.

Examples of Screens in Searching

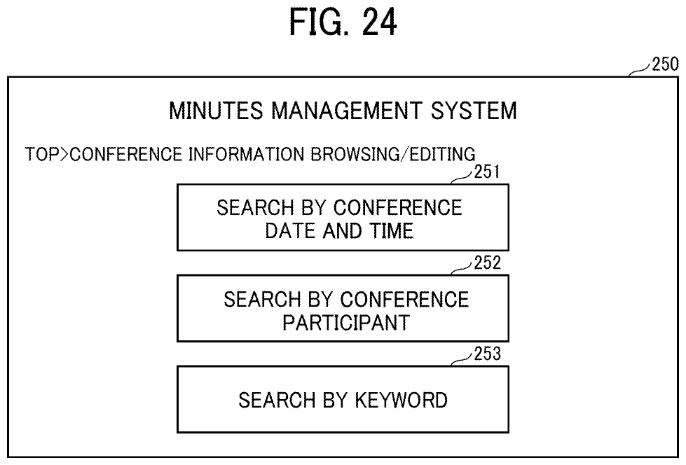

With reference to FIGS. 24 to 27, screens displayed by the terminal apparatus 10 in searching are described. FIG. 24 is a diagram illustrating an example of a search menu screen 250. A user who desires to search for conference information connects the terminal apparatus 10 to the information processing system 50. The screen generation unit 53 of the information processing system 50 generates the search menu screen 250 requested by the user, and transmits the screen information to the terminal apparatus 10.

The search menu screen 250 is a screen that is displayed first by the terminal apparatus 10 in searching. The search menu screen 250 includes a search by conference date and time button 251, a search by conference participant button 252, and a search by keyword button 253. The search by conference date and time button 251 is a button that allows the user to search for conference information by the date and time when the conference is held. The search by conference participant button 252 is a button that allows the user to search for conference information by a name of a participant in the conference. The search by keyword button 253 is a button that allows the user to search for conference information by a keyword. In the present embodiment, a case where the search by conference participant button 252 is pressed will be described.

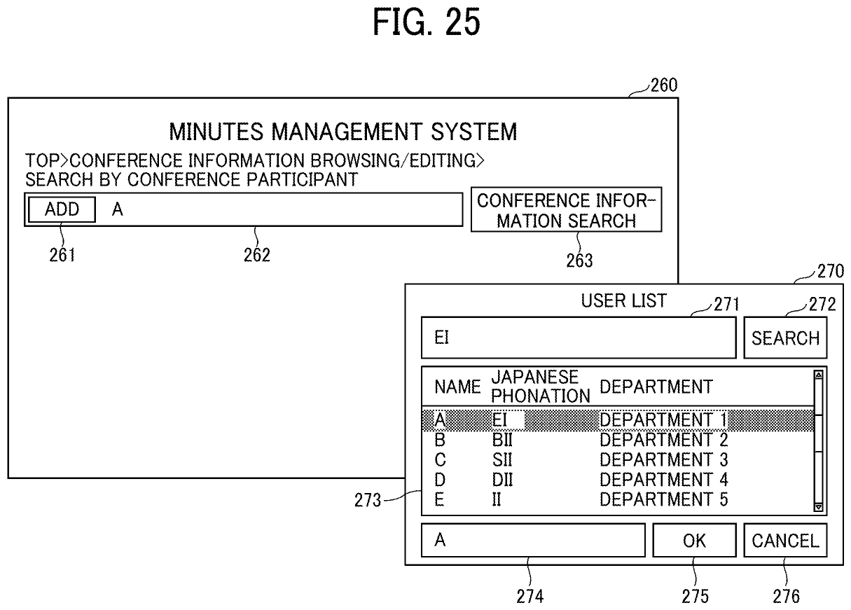

FIG. 25 is a diagram illustrating an example of a search screen 260 displayed by the terminal apparatus 10 when the search by conference participant button 252 is pressed. The search screen 260 is a screen that allows the user to input a name of a participant serving as a search key. The search screen 260 includes an add button 261, a search key field 262, and a conference information search button 263.

When the add button 261 is pressed, a user list screen 270 is displayed. On the user list screen 270, a list of employees and the like who are qualified to participate in the conference is displayed. The user list screen 270 includes a name input field 271, a search button 272, a list field 273, a search target participant field 274, and the like. In the list field 273, a name of an employee, Japanese phonation of the name, a department, and the like are displayed for each employee. The user can select an employee to be used as a search key in the list field 273. The employee selected in the list field 273 is displayed in the search target participant field 274.

Further, when the user inputs a part or all of the name of the participant to be searched for in the name input field 271 and presses the search button 272, names of participants that match the search key are displayed. As illustrated in FIG. 25, when the user inputs “EI” in the name input field 271 and presses the search button 272, a list of employees whose names include “EI,” “E,” or “I” as a part of a name is displayed in the list field 273.

When the user presses an OK button 275 or a cancel button 276, the user list screen 270 closes. Further, in a case where the user presses the OK button 275, the name of the employee displayed in the search target participant field 274 is displayed in the search key field 262 on the search screen 260. When the user presses the conference information search button 263, the name of the employee displayed in the search key field 262 and a search request are transmitted to the information processing system 50.

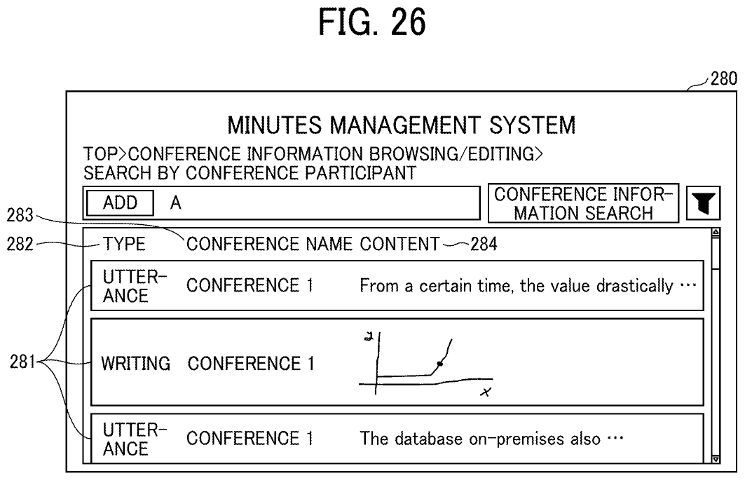

FIG. 26 is a diagram illustrating an example of a search result screen 280 that presents a search result transmitted from the information processing system 50. On the search result screen 280, search results 281 that match the search key in the search key field 262 are displayed. The display order of the search results 281 that match the search key may be in chronological order of conference date and time, and can be rearranged by the name of the conference or the type (utterance or writing).

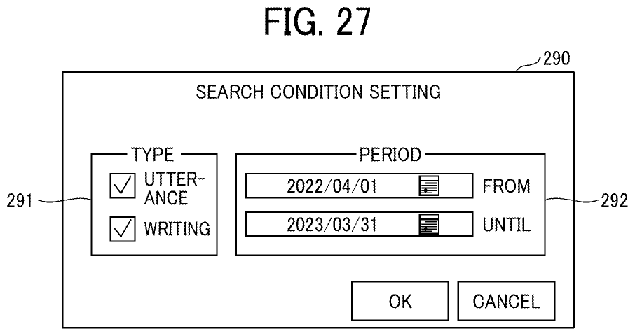

Each of the search results 281 presents information corresponding to a type 282 that indicates the type of information to which the search key is matched, a conference name 283 of a conference in which the record or the object information is recorded, and a content 284 (text data or handwritten data). The type 282 is, for example, utterance indicating text converted from audio data, writing indicating handwritten data, or the like. In a case where the type 282 is the utterance, the content 284 may be a sentence uttered by a talker that is the employee whose name matches the search key, or the sentence and sentences before and after the sentence. In a case where the type 282 is the writing, the content 284 is an image (for example, a thumbnail image) of handwritten data drawn by a writer that is the employee whose name matches the search key. As illustrated in FIG. 27, since the handwritten data itself is displayed on the search result screen 280, the user can easily check the contents of the handwritten data, which the user desires to check, written by the person A.

Further, as illustrated in FIG. 27, a filter setting may be provided for allowing the user to further narrow down the search results. FIG. 27 is a diagram illustrating an example of a search condition setting screen 290. The search condition setting screen 290 includes a record type setting field 291 and a period setting field 292. The search condition setting screen 290 allows the user to narrow down the search results by the type such as utterance or writing and by the date and time when the conference is held.

Processing or Operation

An operation and processing performed by the record creation system 100 based on the above-described configuration are described.

Storage of Composite Image Video

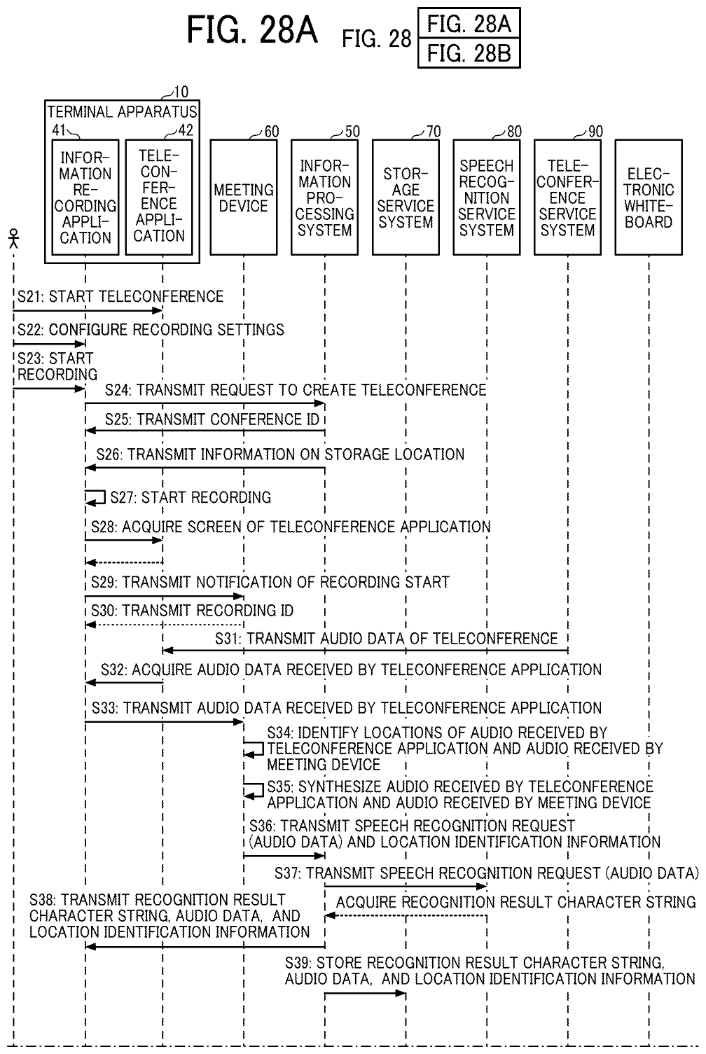

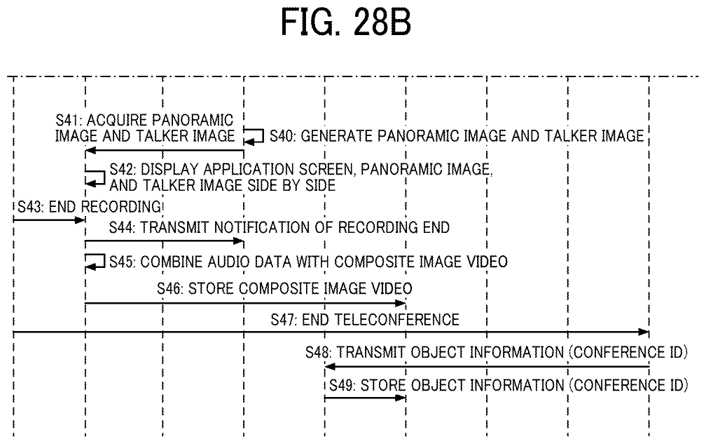

With reference to FIGS. 28A and 28B (FIG. 28), processing of storing a composite image video is described. FIGS. 28A and 28B (FIG. 28) are sequence charts illustrating an example of processing executed by the information recording application 41 to record a panoramic image, a talker image, and an application screen. In the example illustrated in FIGS. 28A and 28B (FIG. 28), speech recognition is performed in real time. In another example, the speech recognition may be collectively performed at fixed time intervals or at a time after the conference ends.

S21: The user operates the teleconference application 42 to start a teleconference. In this example, it is assumed that the teleconference is started between the teleconference application 42 on the terminal apparatus 10 at the own site 102 and another teleconference application 42 on another terminal apparatus 10 at the other site 101. The teleconference application 42 on the terminal apparatus 10 at the own site 102 transmits an image captured by the camera included in the terminal apparatus 10 and audio collected by the microphone included in the terminal apparatus 10 to the other teleconference application 42 on the other terminal apparatus 10 at the other site 101. The other teleconference application 42 on the other terminal apparatus 10 at the other site 101 displays the received image on the display included in the other terminal apparatus 10 and outputs the received audio from the speaker included in the other terminal apparatus 10. Similarly, the other teleconference application 42 on the other terminal apparatus 10 at the other site 101 transmits an image captured by a camera included in the other terminal apparatus 10 and audio collected by a microphone included in the other terminal apparatus 10 to the teleconference application 42 on the terminal apparatus at the own site 102. The teleconference application 42 on the terminal apparatus at the own site 102 displays the received image on the display included in the terminal apparatus 10 and outputs the received audio from the speaker included in the terminal apparatus 10. Each teleconference application 42 repeats this processing to implement the teleconference.

S22: The user configures settings of recording such as an item to be recorded. The operation reception unit 12 implemented by the information recording application 41 receives the settings.

In a case where the teleconference has been scheduled in advance, the user can operate to display a list of teleconferences to select the teleconference with which a composite image video is desired to be associated. Since the user has already logged in to the information processing system 50, the information processing system 50 identifies teleconferences for which the user who has logged in has a right to browse. The information processing system 50 transmits a list of the identified teleconferences to the terminal apparatus 10. Thus, the user selects a teleconference that is being held or to be held. In this way, information related to the teleconference such as the conference ID is determined.

In addition, even in a case where a teleconference has not been scheduled in advance, the user is allowed to create a conference when a composite image video is generated. In the description below, the information recording application 41 creates a conference when creating a composite image video and acquires the conference ID from the information processing system 50.

S23: The user instructs the information recording application 41 to start recording. The operation reception unit 12 implemented by the information recording application 41 receives the instruction to start recording. The display control unit 13 displays a recording-in-progress screen.

S24: Since no teleconference is selected (in other words, no conference ID is determined), the communication unit 11 implemented by the information recording application 41 transmits a teleconference creation request to the information processing system 50.

S25: The communication unit 51 of the information processing system 50 receives the teleconference creation request. The communication management unit 54 acquires a conference ID that is unique and assigned by the conference management system 9. The communication unit 51 transmits the conference ID to the information recording application 41.

S26: The communication management unit 54 transmits information on a storage location (URL of the storage service system 70) of the composite image video (video file) to the information recording application 41 via the communication unit 51.

S27: When the communication unit 11 implemented by the information recording application 41 receives the conference ID and the information on a storage location of the video file, the recording control unit 17 determines that preparation for recording is completed and starts recording.

S28: The application screen acquisition unit 14 implemented by the information recording application 41 requests a screen of an application selected by the user from the selected application. More specifically, the application screen acquisition unit 14 acquires the screen of the application via the OS. In FIGS. 28A and 28B (FIG. 28), a description is given on the assumption that the application selected by the user is the teleconference application 42.

S29: The recording control unit 17 implemented by the information recording application 41 notifies the meeting device 60 of the start of recording via the device communication unit 16. The meeting device 60 transmits the panoramic image and the talker image to the information recording application 41.

S30: In response to receiving the notification of the start of recording by the terminal communication unit 61 of the meeting device 60, recording ID that is unique is assigned. The terminal communication unit 61 transmits the recording ID to the information recording application 41. Alternatively, the recording ID may be assigned by the information recording application 41, or may be acquired from the information processing system 50.

S31: The teleconference service system 90 repeatedly transmits the audio data and the image data transmitted from the other site to the teleconference application.

S32: The audio collection unit 15 implemented by the information recording application 41 acquires the audio data output by the terminal apparatus 10 (audio data received by the teleconference application 42).

S33: The device communication unit 16 transmits the audio data acquired by the audio collection unit 15 and a synthesis request to the meeting device 60.

S34: The terminal communication unit 61 of the meeting device 60 receives the audio data and the synthesis request. The audio collection unit 64 continuously collects audio from the surroundings. The meeting device 60 divides the audio data at the other site received by the terminal communication unit 61 and the audio data at the own site collected by the audio collection unit 64 according to the predetermined rule, and determines a site for each divided audio data based on the sound pressure of each divided audio data.

S35: Next, the audio synthesis unit 65 synthesizes the audio (audio data from the surroundings) collected by the audio collection unit 64 and the audio data at the other site received by the terminal communication unit 61. Accordingly, the synthesized audio data is generated in a state where the audio data at the own site and the audio data at the other site are divided according to the predetermined rule. For example, the audio synthesis unit 65 adds up the audio data at the own site and the audio data at the other site. Since clear audio around the meeting device 60 is recorded, the accuracy of converting audio particularly around the meeting device 60 (in the conference room) into text data increases.

This synthesis of the audio data can also be performed by the terminal apparatus 10. However, distributing the recording function to the terminal apparatus 10 and the audio processing to the meeting device 60 reduces load on each of the terminal apparatus 10 and the meeting device 60. Alternatively, the recording function may be allocated to the meeting device 60, and the audio processing function may be allocated to the terminal apparatus 10.

S36: The terminal communication unit 61 of the meeting device 60 transmits a speech recognition request (the synthesized audio data already divided) and the site identification information to the information processing system 50.

S37: The communication unit 51 of the information processing system 50 receives the speech recognition request (the synthesized audio data already divided) and the site identification information. The text conversion unit 56 transmits the speech recognition request (the synthesized audio data already divided) to the speech recognition service system and acquires a recognition result character string.

S38: The information processing system 50 transmits the recognition result character string, the audio data, and the site identification information to the information recording application 41. In order for the information processing system 50 to transmit these items to the information recording application 41, the meeting device 60 attaches a device identifier of own to the speech recognition request in step S36. The information recording application 41 sets an internet protocol (IP) address of the terminal apparatus 10 and the device identifier of the meeting device 60 acquired from the meeting device 60 in the information processing system 50 in advance. In this way, the information processing system 50 identifies the terminal apparatus 10 based on the device identifier of the meeting device 60.

S39: The communication unit 51 of the information processing system 50 stores the recognition result character string, the audio data, and the site identification information in the same storage location as the storage location of the composite image video indicated by the information on a storage location. Note that the conference ID is attached to each of these items.

S40: Further, the panoramic image generation unit 62 of the meeting device 60 generates a panoramic image, and the talker image generation unit 63 generates a talker image.

S41: The device communication unit 16 implemented by the information recording application 41 repeatedly acquires the panoramic image and the talker image from the meeting device 60. Further, the device communication unit 16 repeatedly requests the meeting device 60 for the synthesized audio data to acquire the synthesized audio data. The device communication unit 16 may send a request to the meeting device 60 to acquire such images and data. Alternatively, the meeting device 60 may automatically transmit the panoramic image and the talker image to the information recording application 41. The meeting device 60 that has received the synthesis request of audio data may automatically transmit the synthesized audio data to the information recording application 41.

S42: The display control unit 13 implemented by the information recording application 41 displays the application screen, the panoramic image, and the talker image side by side. Further, the recording control unit 17 implemented by the information recording application 41 combines the application screen acquired from the teleconference application 42, the panoramic image, and the talker image, and stores the resultant as a composite image video. In other words, the recording control unit 17 combines the application screen, the panoramic image, and the talker image that are repeatedly received by the recording control unit 17 to generate a composite image and designates each composite image to a frame forming a video, to generate a composite image video. In addition, the recording control unit 17 stores the audio data received from the meeting device 60.

The information recording application 41 repeats the above-described steps S32 to S42.

S43: When the teleconference ends and the recording is no longer necessary, the user instructs the information recording application 41 to end recording. The operation reception unit 12 implemented by the information recording application 41 receives the instruction to end recording.

S44: The device communication unit 16 implemented by the information recording application 41 notifies the meeting device 60 of the end of recording. The meeting device 60 continues the generation of the panoramic image and the talker image, and the synthesis of the audio. The meeting device 60 may change the processing load by, for example, changing the resolution or the frame rates (frames per second) depending on whether the recording is in progress.

S45: The recording control unit 17 implemented by the information recording application 41 combines the audio data with the composite image video, to generate a composite image video with audio. In a case where none of the panoramic images, the talker image, and the application screen is stored, the audio data may be independent.

S46: The upload unit 20 implemented by the information recording application 41 stores the composite image video in the storage location of the composite image video indicated by the information on a storage location via the communication unit 11. The composite image video is associated with the conference ID and the recording ID in the recording information storage area 5002. For the composite image video, “Uploaded” is recorded.

The processing from steps S32 to S42 does not have to be executed in the order illustrated in FIG. 28. For example, the order of the synthesis of the audio data and the generation of the composite image video may be switched.

S47: The user instructs the electronic whiteboard 2 to end the teleconference. Alternatively, the user may instruct the terminal apparatus 10 to end the teleconference, and the terminal apparatus 10 transmits a notification of the end of the teleconference to the electronic whiteboard 2. In this case, the notification of the end of the conference may be transmitted to the electronic whiteboard 2 via the information processing system 50.

S48: The communication unit 36 of the electronic whiteboard 2 transmits object information (for example, handwritten data) displayed at the conference to the information processing system 50 with designation of the conference ID. Alternatively, the communication unit 36 may transmit the device identifier of the electronic whiteboard 2 as the designation, in place of the conference ID, to the information processing system 50. In this case, the conference ID is identified by the association information.

S49: When the communication unit 51 of the information processing system 50 receives the object information (handwritten data), the handwritten data dividing unit 57 divides the handwritten data each time the time interval between strokes is equal to or greater than the threshold value. Note that this division may be performed by the electronic whiteboard 2. The information processing system 50 stores the object information in the same storage location as the storage location of the composite image video and the like based on the conference ID.

Since the user is notified of the storage location, the user can share the composite image video with other participants by sending the storage location via e-mail or the like. Even when the composite image video, the audio data, the text data, and the object information are generated by different devices or apparatuses, these video and data are collectively stored in one storage location. Thus, the user or the like can browse the video and the data later in a simple manner.

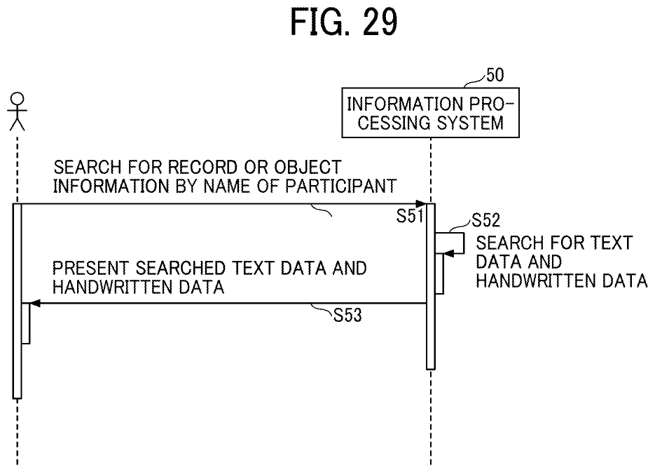

FIG. 29 is a sequence chart illustrating an example operation performed by a user to search for a record and object information recorded in a conference.

S51: The user inputs search conditions on the search screen 260 and the search condition setting screen 290. The operation reception unit 12 of the terminal apparatus 10 receives the input. In this example, an operation to search for a record or object information by a name of a participant is input. The communication unit 11 transmits a search request with designation of the name of the participant to the information processing system 50. Alternatively, the user ID may be designated in place of the name of the participant. The communication unit 11 may also transmit the user ID of the user who is a searcher to the information processing system 50. The user ID of the user used for logging in may have already been identified by the information processing system 50.

S52: The communication unit 51 of the information processing system 50 receives the search request. The search unit 58 searches the storage service system 70 for the record (composite image video, text data) and the object information by the name of the participant. Specifically, first, the search unit 58 determines whether the type of the search target transmitted from the terminal apparatus 10 is handwritten data, text data, or both. The search unit 58 determines a period of the search target based on the date of the conference transmitted from the terminal apparatus 10.

Next, the search unit 58 searches the user information storage area 5004 for the name of the participant and converts the name of the participant into user ID. Then, the search unit 58 searches for the text data by the user ID. That is, the item of the talker ID is searched for by the user ID. The item of the recognition result character string may be searched for by the name of the participant. Further, the search unit 58 searches for the item of the writer ID in the object information by the user ID. As described above, handwritten data and text data (search result character string divided already) that match the name of the participant used as the search key are specified.

The search unit 58 acquires information on a browsing right from the conference information based on the conference ID associated with the handwritten data and the text data that match the search key, and determines that the handwritten data and the text data are allowed to be provided in a case where the searcher (the user ID identified in step S51) is included in the information on the browsing right.

S53: The screen generation unit 53 of the information processing system 50 generates the search result screen 280. The communication unit 51 transmits screen information representing the search result screen 280 to the terminal apparatus 10. The screen generation unit 53 sorts the search results 281 matching the search key in order either by conference date and time, name of the conference, or type (utterance or writing). The communication unit 11 of the terminal apparatus 10 receives the screen information representing the search result screen 280. The display control unit 13 displays the search result screen 280 based on the screen information.

As described above, by associating a writer with one or more strokes that have some meaning, the searching method of the present embodiment allows providing not the entire minutes but the one or more strokes written by a participant that is the writer in meaningful units. Accordingly, the user can easily find the target handwritten data.

Variations

The above-described embodiment is illustrative and does not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

In the present embodiment, the handwritten data is divided by time (time interval). Alternatively, for example, the handwritten data may be divided into units each unit conveying meaningful information. In such a case, the handwritten data dividing unit 57 divides strokes into handwritten data using a handwritten data dividing model created based on machine learning for dividing strokes into handwritten data in meaningful units. The handwritten data dividing unit 57 can divide the strokes in real time or by batch processing.

The terminal apparatus 10 and the meeting device 60 may be configured as a single entity. Alternatively, the meeting device 60 may be externally attached to the terminal apparatus 10. The meeting device 60 may be implemented by a spherical camera, a microphone, and a speaker connected to one another by cables.

Another meeting device 60 may be provided also at the other site 101. The other meeting device 60 at the other site 101 separately generates a composite image video and text data. A plurality of meeting devices 60 may be provided at a single site. In such a case, multiple records are created for each of the plurality of meeting devices 60.

The arrangement of the panoramic image 203, the talker images 204, and the application screen in the composite image video used in the present embodiment is merely an example. The panoramic image 203 may be displayed below the talker images 204. The user may be allowed to change the arrangement, or the user may be allowed to switch between display and non-display individually for the panoramic image 203 and the talker images 204 during replay.

The functional configurations illustrated in, for example, FIG. 10 are divided according to main functions in order to facilitate understanding of the processing executed by the terminal apparatus 10, the meeting device 60, and the information processing system 50. No limitation to a scope of the present disclosure is intended by how the processing units are divided or by the name of the processing units. The processing executed by the terminal apparatus 10, the meeting device 60, and the information processing system 50 may be divided into a greater number of processing units in accordance with the content of the processing. In addition, a single processing unit can be divided to include a greater number of processing units.

The apparatuses or devices described in the above-described embodiment are merely one example of plural computing environments that implement the embodiment disclosed herein. In some embodiments, the information processing system 50 includes a plurality of computing devices, such as a server cluster. The plurality of computing devices communicates with one another through any type of communication link including, for example, a network or a shared memory, and performs the operations disclosed herein.

Further, the information processing system 50 may be configured to share the disclosed processing steps, for example, the processing illustrated in FIGS. 28A, 28B (FIG. 28), and 29, in various combinations. For example, processing executed by a predetermined unit may be executed by a plurality of information processing apparatuses included in the information processing system 50. Further, the components of the information processing system 50 may be integrated into one server apparatus or may be divided into a plurality of apparatuses.

Each function of the embodiment described above may be implemented by one processing circuit or a plurality of processing circuits. The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality.

Aspects of the present disclosure are, for example, as follows.

In Aspect 1, an information processing system includes a search unit and a communication unit. In response to receiving, from a terminal apparatus, a search request for searching minutes using user information as a search key, the minutes including handwritten data having been displayed on a display, the search unit searches a storage device that stores, in association with user information, a plurality of pieces of handwritten data divided into one or more groups in accordance with a predetermined rule, to obtain a search result including the one or more groups of handwritten data that match the user information. The communication unit transmits the search result including the one or more groups of handwritten data that match the user information to the terminal apparatus.

According to Aspect 2, in the information processing system of Aspect 1, the handwritten data includes one or more pieces of stroke data and the predetermined rule causes grouping of the plurality of pieces of handwritten data according to a time interval between subsequent pieces of stroke data.

According to Aspect 3, in the information processing system of Aspect 1 or 2, the one or more pieces of stroke data, in the handwritten data, are each associated with time information and the user information. A handwritten data dividing unit included in the information processing system divides the plurality of pieces of handwritten data in a case where an interval between times of two subsequent pieces of stroke data, indicated by the time information, is equal to or greater than a threshold value and stores the user information associated with each piece of stroke data in the storage device in association with each group of the handwritten data divided according to the interval indicated by the time information.

According to Aspect 4, in the information processing system of any one of Aspects 1 to 3, the communication unit transmits the search result including images of the one or more groups of handwritten data that match the user information to the terminal apparatus.

According to Aspect 5, in the information processing system of any one of Aspects 1 to 4, the terminal apparatus is connected to a device that records audio and video. The storage device stores text data converted by speech recognition from audio received from the terminal apparatus in association with the user information, the audio being an utterance made by a user. The search unit searches for the user information associated with the text data, using the user information transmitted from the terminal apparatus.

According to Aspect 6, in the information processing system of Aspect 5, the search request includes a setting indicating whether to search text data or handwritten data. The search unit searches for the user information associated with text data or handwritten data indicated by the setting.

According to Aspect 7, in the information processing system of Aspect 5 or 6, the communication unit receives information on a right to browse together with the search request from the terminal apparatus. The information on a right to browse is associated with the text data and the handwritten data. The search unit excludes, from the search result, the handwritten data or the text data associated with information on a right to browse that is not satisfied.

According to Aspect 8, in the information processing system of any one of Aspects 1 to 7, the search unit sorts the one or more groups of handwritten data in the search result according to a date and time when a conference is held or a name of the conference.

According to Aspect 9, in the information processing system of any one of Aspects 1 to 8, the plurality of pieces of handwritten data is associated with a plurality of pieces of the user information each indicating a user who hand-drafts one or more pieces of stroke data included in the handwritten data. The search unit searches for the plurality of pieces of user information. In a case where at least one of the plurality of pieces of user information that matches the user information transmitted from the terminal apparatus has been searched for, the communication unit transmits the search result including the handwritten data matching the user information to the terminal apparatus.

1. An information processing system comprising circuitry configured to:
in response to receiving, from a terminal apparatus, a search request for searching minutes using user information as a search key, the minutes including handwritten data having been displayed on a display, search a memory that stores, in association with user information, a plurality of pieces of handwritten data divided into one or more groups in accordance with a predetermined rule, to obtain a search result including the one or more groups of handwritten data that match the user information; and
transmit the search result including the one or more groups of handwritten data that match the user information to the terminal apparatus.

2. The information processing system according to claim 1, wherein:
the handwritten data includes one or more pieces of stroke data; and
the predetermined rule causes grouping of the plurality of pieces of handwritten data according to a time interval between subsequent pieces of stroke data.

3. The information processing system according to claim 2, wherein:
the one or more pieces of stroke data, in the handwritten data, are each associated with time information and the user information; and
the circuitry is further configured to:
divide the plurality of pieces of handwritten data in a case where an interval between times of two subsequent pieces of stroke data, indicated by the time information, is equal to or greater than a threshold value; and
store the user information associated with each piece of stroke data in the memory in association with each group of the handwritten data divided according to the interval indicated by the time information.

4. The information processing system according to claim 1, wherein
the circuitry is configured to transmit the search result including images of the one or more groups of handwritten data that match the user information to the terminal apparatus.

5. The information processing system according to claim 1, wherein:
the terminal apparatus is connected to a device that records audio and video;
the memory stores text data converted by speech recognition from audio received from the terminal apparatus in association with the user information, the audio being an utterance made by a user; and
the circuitry is configured to search for the user information associated with the text data, using the user information transmitted from the terminal apparatus.

6. The information processing system according to claim 5, wherein:
the search request includes a setting indicating whether to search text data or handwritten data; and
the circuitry is configured to search for the user information associated with text data or handwritten data indicated by the setting.

7. The information processing system according to claim 5, wherein:
the circuitry is configured to receive information on a right to browse together with the search request from the terminal apparatus;
the information on a right to browse is associated with the text data and the handwritten data; and
the circuitry is further configured to exclude, from the search result, the handwritten data or the text data associated with information on a right to browse that is not satisfied.

8. The information processing system according to claim 1, wherein
the circuitry is further configured to sort the one or more groups of handwritten data in the search result according to a date and time when a conference is held or a name of the conference.

9. The information processing system according to claim 1, wherein:
the plurality of pieces of handwritten data is associated with a plurality of pieces of the user information each indicating a user who hand-drafts one or more pieces of stroke data included in the handwritten data; and
the circuitry is configured to:
search for the plurality of pieces of user information; and
in a case where at least one of the plurality of pieces of user information that matches the user information transmitted from the terminal apparatus has been searched for, transmit the search result including the handwritten data matching the user information to the terminal apparatus.

10. An information processing method comprising:
receiving, from a terminal apparatus, a search request for searching minutes using user information as a search key, the minutes including handwritten data having been displayed on a display;
searching a memory that stores, in association with user information, a plurality of pieces of handwritten data divided into one or more groups in accordance with a predetermined rule, to obtain a search result including the one or more groups of handwritten data that match the user information; and
transmitting a search result including the one or more groups of handwritten data that match the user information to the terminal apparatus.

11. A non-transitory recording medium storing a plurality of program codes which, when executed by one or more processors, causes the processors to perform an information processing method, the method comprising:
receiving, from a terminal apparatus, a search request for searching minutes using user information as a search key, the minutes including handwritten data having been displayed on a display;
searching a memory that stores, in association with user information, a plurality of pieces of handwritten data divided into one or more groups in accordance with a predetermined rule, to obtain a search result including the one or more groups of handwritten data that match the user information; and
transmitting a search result including the one or more groups of handwritten data that match the user information to the terminal apparatus.
